(19) United States
(12) Patent Application Publication
(10) Pub. No.: US 2026/0332822 A1
(43) Pub. Date: Oct. 22, 2026

(54) POINT CLOUD DATA TRANSMISSION DEVICE, POINT CLOUT DATA TRANSMISSION METHOD, POINT CLOUD DATA RECEPTION DEVICE, AND POINT CLOUD DATA RECEPTION METHOD

(71) Applicant: LG Electronics Inc., Seoul (KR)

(72) Inventors: Hyejung HUR, Seoul (KR); Yousun PARK, Seoul (KR)

(21) Appl. No.: 19/111,426

(22) PCT Filed: Sep. 22, 2023
(86) PCT No.: PCT/KR2023/014539

§ 371 Date: Mar. 13, 2025

(30) Foreign Application Priority Data
Sep. 22, 2022 (KR) 10-2022-0120283

(51) Int. Cl. H04N 19/62; G01S 17/89; H04N 19/70

(52) U.S. Cl. CPC H04N 19/62; G01S 17/89; H04N 19/70

(57) ABSTRACT

A point cloud data transmission method, according to embodiments, comprises the steps of: encoding point cloud data; and transmitting the encoded point cloud data and signaling information. The step of encoding the point cloud data may comprise the steps of: compensating for refraction occurring in the point cloud data; separating points of the refraction-compensated point cloud data into roads and objects; and encoding geometry information and attribute information of the points separated into the roads and objects.

### TECHNICAL FIELD

Embodiments relate to a method and device for processing point cloud content.

### BACKGROUND ART

Point cloud content is content represented by a point cloud, which is a set of points belonging to a coordinate system representing a three-dimensional space (or volume). The point cloud content may express media configured in three dimensions, and is used to provide various services such as virtual reality (VR), augmented reality (AR), mixed reality (MR), XR (Extended Reality), and self-driving services. However, tens of thousands to hundreds of thousands of point data are required to represent point cloud content. Therefore, there is a need for a method for efficiently processing a large amount of point data.

### DISCLOSURE

### Technical Problem

An object of the present disclosure devised to solve the above-described problems is to provide a point cloud data transmission device, a point cloud data transmission method, a point cloud data reception device, and a point cloud data reception method for efficiently transmitting and receiving a point cloud.

Another object of the present disclosure is to provide a point cloud data transmission device, a point cloud data transmission method, a point cloud data reception device, and a point cloud data reception method for addressing latency and encoding/decoding complexity.

Another object of the present disclosure is to provide a point cloud data transmission device, a point cloud data transmission method, a point cloud data reception device, and a point cloud data reception method for improving the compression performance of the point cloud by improving the technique of encoding attribute information of geometry-based point cloud compression (G-PCC).

Another object of the present disclosure is to provide a point cloud data transmission device, a point cloud data transmission method, a point cloud data reception device, and a point cloud data reception method for improving performance of compression of point cloud data acquired through fixed LiDAR.

Objects of the present disclosure are not limited to the aforementioned objects, and other objects of the present disclosure which are not mentioned above will become apparent to those having ordinary skill in the art upon examination of the following description.

### Technical Solution

To achieve these objects and other advantages and in accordance with the purpose of the disclosure, as embodied and broadly described herein, a method of transmitting point cloud data may include acquiring point cloud data using a light detection and ranging (LiDAR) system, encoding the point cloud data, and transmitting the point cloud data and signaling information.

According to embodiments, the encoding of the point cloud data may include compensating for refraction occurring in the point cloud data, splitting points in the refraction-compensated point cloud data into a road and an object, and encoding geometry information and attribute information. The geometry information may include positions of the points split into the road and the object, and the attribute information may include one or more attribute values.

According to embodiments, the signaling information may include refraction compensation-related information related to the point cloud data.

According to embodiments, the compensating for refraction may include compensating for the refraction of the points in the point cloud data based on a value of Z in position information (X, Y, Z) about the points.

According to embodiments, values of X and Y in the position information (X, Y, Z) are acquired based on deflection angles acquired by scanning a laser beam of the LiDAR system along an x-axis and y-axis and target distance information related to the laser beam, and the value of Z may be acquired based on the values of X and Y, the deflection angles, and the target distance information related to the laser beam.

According to embodiments, the compensating for refraction may include compensating for refraction of the points in the point cloud data by applying a threshold according to positions of the points in the point cloud data in an xy plane.

According to embodiments, the splitting of the road and the object may include classifying each of the points in the point cloud data as the road or the object based on the value of Z of a corresponding one of the points.

According to embodiments, a device for transmitting point cloud data may include an acquirer configured to acquire point cloud data using a light detection and ranging (LiDAR) system, an encoder configured to encode the point cloud data, and a transmitter configured to transmit the point cloud data and signaling information.

According to embodiments, the encoder may include a refraction compensator configured to compensate for refraction occurring in the point cloud data, a road-object splitter configured to split points in the refraction-compensated point cloud data into a road and an object, and an encoder configured to encode geometry information and attribute information. The geometry information may include positions of the points split into the road and the object, and the attribute information may include one or more attribute values.

According to embodiments, the signaling information may include refraction compensation-related information related to the point cloud data.

According to embodiments, the refraction compensator may compensate for the refraction of the points in the point cloud data based on a value of Z in position information (X, Y, Z) about the points.

According to embodiments, values of X and Y in the position information (X, Y, Z) are acquired based on deflection angles acquired by scanning a laser beam of the LiDAR system along an x-axis and y-axis and target distance information related to the laser beam, and the value of Z is acquired based on the values of X and Y, the deflection angles, and the target distance information related to the laser beam.

According to embodiments, the refraction compensator may compensate for refraction of the points in the point cloud data by applying a threshold according to positions of the points in the point cloud data in an xy plane.

According to embodiments, the road-object splitter may classify each of the points in the point cloud data as the road or the object based on the value of Z of a corresponding one of the points.

According to embodiments, a method of receiving point cloud data may include receiving compressed point cloud data and signaling information, decoding the point cloud data based on the signaling information, and rendering the decoded point cloud data based on the signaling information.

According to embodiments, the decoding of the point cloud data may include performing a refraction compensation inverse transform on the compressed point cloud data, and reconstructing geometry information and attribute information related to the point cloud data subjected to the refraction compensation inverse transform.

According to embodiments, the signaling information may include refraction compensation-related information.

### Advantageous Effects

The point cloud data transmission method, the point cloud data transmission device, the point cloud data reception method, and the reception device according to embodiments may provide a quality point cloud service.

The point cloud data transmission method, point cloud data transmission device, point cloud data reception method, and point cloud data reception device according to embodiments may achieve various video codec methods.

The point cloud data transmission method, point cloud data transmission device, point cloud data reception method, and point cloud data reception device according to embodiments may provide universal point cloud content such as an autonomous driving service.

The point cloud data transmission method, point cloud data transmission device, point cloud data reception method, and point cloud data reception device according to embodiments may perform space-adaptive partition of point cloud data for independent encoding and decoding of the point cloud data, thereby improving parallel processing and providing scalability.

The point cloud data transmission method, point cloud data transmission device, point cloud data reception method, and point cloud data reception device according to embodiments may perform encoding and decoding by partitioning the point cloud data in units of tiles and/or slices, and signal necessary data therefor, thereby improving encoding and decoding performance of the point cloud.

A point cloud data transmission method, point cloud data transmission device, point cloud data reception method, and point cloud data reception device according to embodiments may perform refraction compensation prior to compression of the point cloud data acquired through fixed LiDAR, separate the points in the point cloud data into a road and objects based on the refraction compensation, and perform compression, thereby improving performance of compression of point cloud data.

A point cloud data transmission method, point cloud data transmission device, point cloud data reception method, and point cloud data reception device according to embodiments may perform refraction compensation prior to compression of the point cloud data, thereby accurately separating points in the point cloud data acquired through fixed LiDAR on a sloping or curved road into a road and object.

### DESCRIPTION OF DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 shows an exemplary point cloud content providing system according to embodiments;

FIG. 2 is a block diagram illustrating a point cloud content providing operation according to embodiments;

FIG. 3 illustrates an exemplary point cloud encoder according to embodiments;

FIG. 4 shows an example of an octree and occupancy code according to embodiments;

FIG. 5 illustrates an example of point configuration in each LOD according to embodiments;

FIG. 6 illustrates an example of point configuration in each LOD according to embodiments;

FIG. 7 illustrates a point cloud decoder according to embodiments;

FIG. 8 illustrates an exemplary transmission device according to embodiments;

FIG. 9 illustrates an exemplary reception device according to embodiments;

FIG. 10 illustrates an exemplary structure operable in connection with point cloud data transmission/reception methods/devices according to embodiments;

FIG. 11-(a) is a diagram illustrating an example of a spinning LiDAR system according to embodiments;

FIG. 11-(b) is a diagram illustrating an example of a fixed LiDAR system according to embodiments;

FIG. 12 illustrates an example method of acquiring points using an optical lens according to embodiments;

FIGS. 13-(a) and 13-(b) illustrate an example before refraction compensation and an example after refraction compensation according to embodiments;

FIG. 14 is a diagram showing an example xy-plane obtained by applying refraction compensation according to embodiments;

FIG. 15 is a diagram illustrating another example of a point cloud transmission device according to embodiments;

FIG. 16 is a diagram illustrating another example of a point cloud transmission device according to embodiments;

FIG. 17 is a diagram illustrating another example of a point cloud transmission device according to embodiments;

FIG. 18 is a diagram illustrating another example of a point cloud reception device according to embodiments;

FIG. 19 is a diagram illustrating another example of a point cloud reception device according to embodiments;

FIG. 20 is a diagram illustrating another example of a point cloud reception device according to embodiments;

FIG. 21 illustrates an example bitstream structure according to embodiments;

FIG. 22 shows another example syntax structure of a sequence parameter set according to embodiments;

FIG. 23 shows an syntax structure of a tile parameter set according to embodiments;

FIG. 24 shows another example syntax structure of a geometry parameter set according to embodiments;

FIG. 25 illustrates an example syntax structure of an attribute parameter set according to embodiments;

FIG. 26 shows an example syntax structure of a geometry slice header according to embodiments;

FIG. 27 is a flowchart of a method of transmitting point cloud data according to embodiments; and

FIG. 28 is a flowchart of a method of receiving point cloud data according to embodiments.

### BEST MODE

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. It should be noted that the following examples are only for embodying the present disclosure and do not limit the scope of the present disclosure. What can be easily inferred by an expert in the technical field to which the present disclosure belongs from the detailed description and examples of the present disclosure is to be interpreted as being within the scope of the present disclosure.

The detailed description in this present specification should be construed in all aspects as illustrative and not restrictive. The scope of the disclosure should be determined by the appended claims and their legal equivalents, and all changes coming within the meaning and equivalency range of the appended claims are intended to be embraced therein.

Reference will now be made in detail to the preferred embodiments of the present disclosure, examples of which are illustrated in the accompanying drawings. The detailed description, which will be given below with reference to the accompanying drawings, is intended to explain exemplary embodiments of the present disclosure, rather than to show the only embodiments that can be implemented according to the present disclosure. The following detailed description includes specific details in order to provide a thorough understanding of the present disclosure. However, it will be apparent to those skilled in the art that the present disclosure may be practiced without such specific details. Although most terms used in this specification have been selected from general ones widely used in the art, some terms have been arbitrarily selected by the applicant and their meanings are explained in detail in the following description as needed. Thus, the present disclosure should be understood based upon the intended meanings of the terms rather than their simple names or meanings. In addition, the following drawings and detailed description should not be construed as being limited to the specifically described embodiments, but should be construed as including equivalents or substitutes of the embodiments described in the drawings and detailed description.

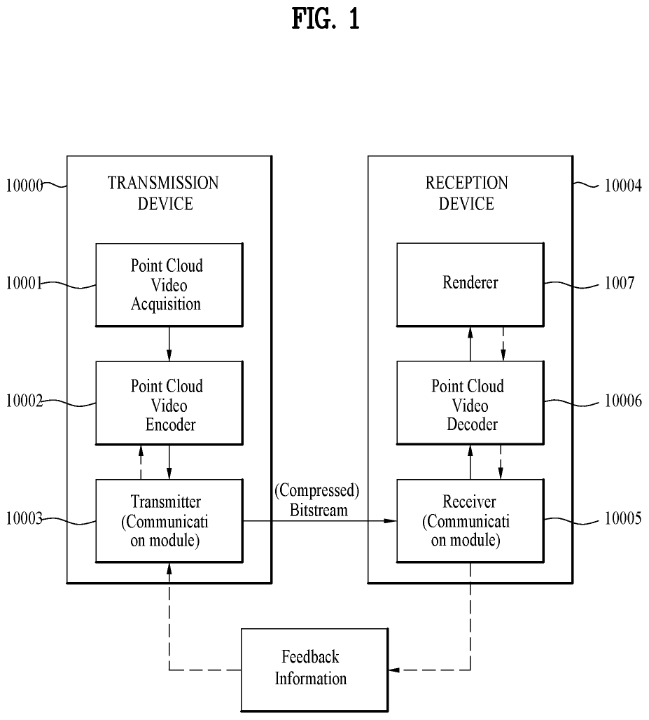

FIG. 1 shows an exemplary point cloud content providing system according to embodiments.

The point cloud content providing system illustrated in FIG. 1 may include a transmission device 10000 and a reception device 10004. The transmission device 10000 and the reception device 10004 are capable of wired or wireless communication to transmit and receive point cloud data.

The point cloud data transmission device 10000 according to the embodiments may secure and process point cloud video (or point cloud content) and transmit the same. According to embodiments, the transmission device 10000 may include a fixed station, a base transceiver system (BTS), a network, an artificial intelligence (AI) device and/or system, a robot, an AR/VR/XR device and/or server. According to embodiments, the transmission device 10000 may include a device, a robot, a vehicle, an AR/VR/XR device, a portable device, a home appliance, an Internet of Thing (IoT) device, and an AI device/server which are configured to perform communication with a base station and/or other wireless devices using a radio access technology (e.g., 5G New RAT (NR), Long Term Evolution (LTE)).

The transmission device 10000 according to the embodiments includes a point cloud video acquisition unit 10001, a point cloud video encoder 10002, and/or a transmitter (or communication module) 10003.

The point cloud video acquisition unit 10001 according to the embodiments acquires a point cloud video through a processing process such as capture, synthesis, or generation. The point cloud video is point cloud content represented by a point cloud, which is a set of points positioned in a 3D space, and may be referred to as point cloud video data, point cloud data, or the like. The point cloud video according to the embodiments may include one or more frames. One frame represents a still image/picture. Therefore, the point cloud video may include a point cloud image/frame/picture, and may be referred to as a point cloud image, frame, or picture.

The point cloud video encoder 10002 according to the embodiments encodes the acquired point cloud video data. The point cloud video encoder 10002 may encode the point cloud video data based on point cloud compression coding. The point cloud compression coding according to the embodiments may include geometry-based point cloud compression (G-PCC) coding and/or video-based point cloud compression (V-PCC) coding or next-generation coding. The point cloud compression coding according to the embodiments is not limited to the above-described embodiment. The point cloud video encoder 10002 may output a bitstream containing the encoded point cloud video data. The bitstream may contain not only the encoded point cloud video data, but also signaling information related to encoding of the point cloud video data.

The transmitter 10003 according to the embodiments transmits the bitstream containing the encoded point cloud video data. The bitstream according to the embodiments is encapsulated in a file or segment (e.g., a streaming segment), and is transmitted over various networks such as a broadcasting network and/or a broadband network. Although not shown in the figure, the transmission device 10000 may include an encapsulator (or an encapsulation module) configured to perform an encapsulation operation. According to embodiments, the encapsulator may be included in the transmitter 10003. According to embodiments, the file or segment may be transmitted to the reception device 10004 over a network, or stored in a digital storage medium (e.g., USB, SD, CD, DVD, Blu-ray, HDD, SSD, etc.). The transmitter 10003 according to the embodiments is capable of wired/wireless communication with the reception device 10004 (or the receiver 10005) over a network of 4G, 5G, 6G, etc. In addition, the transmitter may perform a necessary data processing operation according to the network system (e.g., a 4G, 5G or 6G communication network system). The transmission device 10000 may transmit the encapsulated data in an on-demand manner.

The reception device 10004 according to the embodiments includes a receiver 10005, a point cloud video decoder 10006, and/or a renderer 10007. According to embodiments, the reception device 10004 may include a device, a robot, a vehicle, an AR/VR/XR device, a portable device, a home appliance, an Internet of Things (IoT) device, and an AI device/server which are configured to perform communication with a base station and/or other wireless devices using a radio access technology (e.g., 5G New RAT (NR), Long Term Evolution (LTE)).

The receiver 10005 according to the embodiments receives the bitstream containing the point cloud video data or the file/segment in which the bitstream is encapsulated from the network or storage medium. The receiver 10005 may perform necessary data processing according to the network system (e.g., a communication network system of 4G, 5G, 6G, etc.). The receiver 10005 according to the embodiments may decapsulate the received file/segment and output a bitstream. According to embodiments, the receiver 10005 may include a decapsulator (or a decapsulation module) configured to perform a decapsulation operation. The decapsulator may be implemented as an element (or component) separate from the receiver 10005.

The point cloud video decoder 10006 decodes the bitstream containing the point cloud video data. The point cloud video decoder 10006 may decode the point cloud video data according to the method by which the point cloud video data is encoded (e.g., in a reverse process of the operation of the point cloud video encoder 10002). Accordingly, the point cloud video decoder 10006 may decode the point cloud video data by performing point cloud decompression coding, which is the reverse process to the point cloud compression. The point cloud decompression coding includes G-PCC coding.

The renderer 10007 renders the decoded point cloud video data. In one embodiment, the renderer 10007 may render the decoded point cloud video data according to a viewport or the like. The renderer 10007 may render not only the point cloud video data but also audio data to output point cloud content. According to embodiments, the renderer 10007 may include a display configured to display the point cloud content. According to embodiments, the display may be implemented as a separate device or component rather than being included in the renderer 10007.

The arrows indicated by dotted lines in the drawing represent a transmission path of feedback information acquired by the reception device 10004. The feedback information is information for reflecting interactivity with a user who consumes the point cloud content, and includes information about the user (e.g., head orientation information, viewport information, and the like). In particular, when the point cloud content is content for a service (e.g., self-driving service, etc.) that requires interaction with the user, the feedback information may be provided to the content transmitting side (e.g., the transmission device 10000) and/or the service provider. According to embodiments, the feedback information may be used in the reception device 10004 as well as the transmission device 10000, or may not be provided.

The head orientation information according to the embodiments may represent information about a position, orientation, angle, and motion of a user's head. The reception device 10004 according to the embodiments may calculate viewport information based on the head orientation information. The viewport information is information about a region of a point cloud video that the user is viewing (that is, a region that the user is currently viewing). That is, the viewport information is information about a region that the user is currently viewing in the point cloud video. In other words, the viewport or viewport region may represent a region that the user is viewing in the point cloud video. A viewpoint is a point that the user is viewing in the point cloud video, and may represent a center point of the viewport region. That is, the viewport is a region centered on a viewpoint, and the size and shape of the region may be determined by a field of view (FOV). Accordingly, the reception device 10004 may extract the viewport information based on a vertical or horizontal FOV supported by the device as well as the head orientation information. In addition, the reception device 10004 may perform gaze analysis or the like based on the head orientation information and/or the viewport information to determine the way the user consumes a point cloud video, a region at which the user gazes in the point cloud video, and the gaze time. According to embodiments, the reception device 10004 may transmit feedback information including the result of the gaze analysis to the transmission device 10000. According to embodiments, a device such as a VR/XR/AR/MR display may extract a viewport region based on the position/orientation of a user's head and a vertical or horizontal FOV supported by the device. According to embodiments, the head orientation information and the viewport information may be referred to as feedback information, signaling information, or metadata.

The feedback information according to the embodiments may be acquired in the rendering and/or display process. The feedback information may be secured by one or more sensors included in the reception device 10004. According to embodiments, the feedback information may be secured by the renderer 10007 or a separate external element (or device, component, or the like). The dotted lines in FIG. 1 represent a process of transmitting the feedback information secured by the renderer 10007. The feedback information may not only be transmitted to the transmitting side, but also be consumed at the receiving side. That is, the point cloud content providing system may process (encode/decode/render) point cloud data based on the feedback information. For example, the point cloud video decoder 10006 and the renderer 10007 may preferentially decode and render only the point cloud video for a region currently viewed by the user, based on the feedback information, namely, the head orientation information and/or the viewport information.

Furthermore, the reception device 10004 may transmit the feedback information to the transmission device 10000. The transmission device 10000 (or the point cloud video encoder 10002) may perform an encoding operation based on the feedback information. Accordingly, the point cloud content providing system may efficiently process necessary data (e.g., point cloud data corresponding to the user's head position) based on the feedback information rather than processing (encoding/decoding) the entire point cloud data, and provide point cloud content to the user.

According to embodiments, the transmission device 10000 may be called an encoder, a transmission device, a transmitter, transmission system or the like, and the reception device 10004 may be called a decoder, a receiving device, a receiver, receiving system or the like.

The point cloud data processed in the point cloud content providing system of FIG. 1 according to embodiments (through a series of processes of acquisition/encoding/transmission/decoding/rendering) may be referred to as point cloud content data or point cloud video data. According to embodiments, the point cloud content data may be used as a concept covering metadata or signaling information related to the point cloud data.

The elements of the point cloud content providing system illustrated in FIG. 1 may be implemented by hardware, software, a processor, and/or a combination thereof.

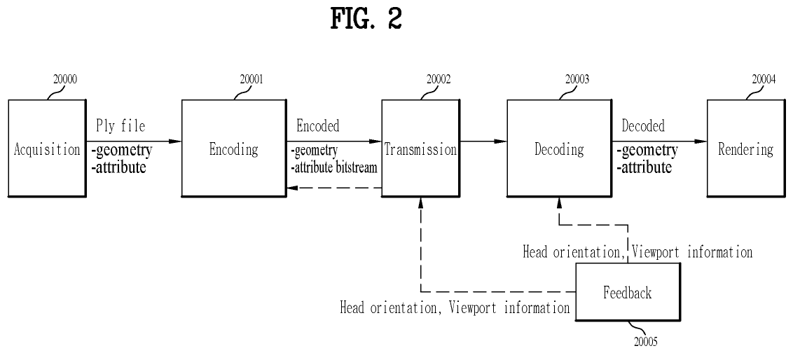

FIG. 2 is a block diagram illustrating a point cloud content providing operation according to embodiments.

The block diagram of FIG. 2 shows the operation of the point cloud content providing system described in FIG. 1. As described above, the point cloud content providing system may process point cloud data based on point cloud compression coding (e.g., G-PCC).

The point cloud content providing system according to the embodiments (e.g., the point cloud transmission device 10000 or the point cloud video acquisition unit 10001) may acquire a point cloud video (20000). The point cloud video is represented by a point cloud belonging to a coordinate system for expressing a 3D space. The point cloud video according to the embodiments may include a Ply (Polygon File format or the Stanford Triangle format) file. When the point cloud video has one or more frames, the acquired point cloud video may include one or more Ply files. The Ply files contain point cloud data, such as point geometry and/or attributes. The geometry includes positions of points. The position of each point may be represented by parameters (e.g., values of the X, Y, and Z axes) representing a three-dimensional coordinate system (e.g., a coordinate system composed of X, Y and Z axes). The attributes include attributes of points (e.g., information about texture, color (in YCbCr or RGB), reflectance r, transparency, etc. of each point). A point has one or more attributes. For example, a point may have an attribute that is a color, or two attributes that are color and reflectance. According to embodiments, the geometry may be called positions, geometry information, geometry data, position information, position data, or the like, and the attribute may be called attributes, attribute information, attribute data, or the like. The point cloud content providing system (e.g., the point cloud transmission device 10000 or the point cloud video acquisition unit 10001) may secure point cloud data from information (e.g., depth information, color information, etc.) related to the acquisition process of the point cloud video.

The point cloud content providing system (e.g., the transmission device 10000 or the point cloud video encoder 10002) according to the embodiments may encode the point cloud data (20001). The point cloud content providing system may encode the point cloud data based on point cloud compression coding. As described above, the point cloud data may include the geometry information and attribute information about a point. Accordingly, the point cloud content providing system may perform geometry encoding of encoding the geometry and output a geometry bitstream. The point cloud content providing system may perform attribute encoding of encoding attributes and output an attribute bitstream. According to embodiments, the point cloud content providing system may perform the attribute encoding based on the geometry encoding. The geometry bitstream and the attribute bitstream according to the embodiments may be multiplexed and output as one bitstream. The bitstream according to the embodiments may further contain signaling information related to the geometry encoding and attribute encoding.

The point cloud content providing system (e.g., the transmission device 10000 or the transmitter 10003) according to the embodiments may transmit the encoded point cloud data (20002). As illustrated in FIG. 1, the encoded point cloud data may be represented by a geometry bitstream and an attribute bitstream. In addition, the encoded point cloud data may be transmitted in the form of a bitstream together with signaling information related to encoding of the point cloud data (e.g., signaling information related to the geometry encoding and the attribute encoding). The point cloud content providing system may encapsulate a bitstream that carries the encoded point cloud data and transmit the same in the form of a file or segment.

The point cloud content providing system (e.g., the reception device 10004 or the receiver 10005) according to the embodiments may receive the bitstream containing the encoded point cloud data. In addition, the point cloud content providing system (e.g., the reception device 10004 or the receiver 10005) may demultiplex the bitstream.

The point cloud content providing system (e.g., the reception device 10004 or the point cloud video decoder 10005) may decode the encoded point cloud data (e.g., the geometry bitstream, the attribute bitstream) transmitted in the bitstream. The point cloud content providing system (e.g., the reception device 10004 or the point cloud video decoder 10005) may decode the point cloud video data based on the signaling information related to encoding of the point cloud video data contained in the bitstream. The point cloud content providing system (e.g., the reception device 10004 or the point cloud video decoder 10005) may decode the geometry bitstream to reconstruct the positions (geometry) of points. The point cloud content providing system may reconstruct the attributes of the points by decoding the attribute bitstream based on the reconstructed geometry. The point cloud content providing system (e.g., the reception device 10004 or the point cloud video decoder 10005) may reconstruct the point cloud video based on the positions according to the reconstructed geometry and the decoded attributes.

The point cloud content providing system according to the embodiments (e.g., the reception device 10004 or the renderer 10007) may render the decoded point cloud data (20004). The point cloud content providing system (e.g., the reception device 10004 or the renderer 10007) may render the geometry and attributes decoded through the decoding process, using various rendering methods. Points in the point cloud content may be rendered to a vertex having a certain thickness, a cube having a specific minimum size centered on the corresponding vertex position, or a circle centered on the corresponding vertex position. All or part of the rendered point cloud content is provided to the user through a display (e.g., a VR/AR display, a general display, etc.).

The point cloud content providing system (e.g., the reception device 10004) according to the embodiments may secure feedback information (20005). The point cloud content providing system may encode and/or decode point cloud data based on the feedback information. The feedback information and the operation of the point cloud content providing system according to the embodiments are the same as the feedback information and the operation described with reference to FIG. 1, and thus a detailed description thereof is omitted.

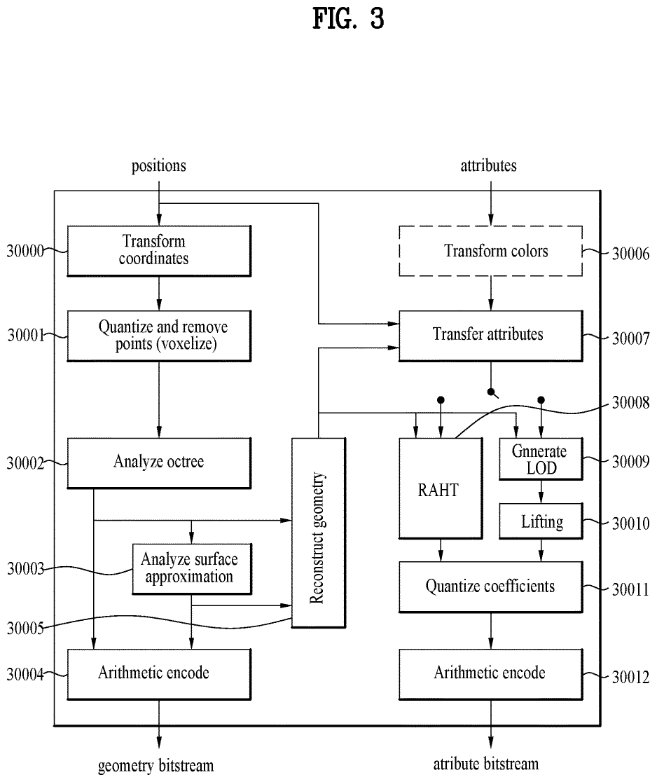

FIG. 3 illustrates an exemplary point cloud encoder according to embodiments.

FIG. 3 shows an example of the point cloud video encoder 10002 of FIG. 1. The point cloud encoder reconstructs and encodes point cloud data (e.g., positions and/or attributes of the points) to adjust the quality of the point cloud content (to, for example, lossless, lossy, or near-lossless) according to the network condition or applications. When the overall size of the point cloud content is large (e.g., point cloud content of 60 Gbps is given for 30 fps), the point cloud content providing system may fail to stream the content in real time. Accordingly, the point cloud content providing system may reconstruct the point cloud content based on the maximum target bitrate to provide the same in accordance with the network environment or the like.

As described with reference to FIGS. 1 and 2, the point cloud encoder may perform geometry encoding and attribute encoding. The geometry encoding is performed before the attribute encoding.

The point cloud video encoder according to the embodiments includes a coordinate transformer (Transform coordinates) 30000, a quantizer (Quantize and remove points (voxelize)) 30001, an octree analyzer (Analyze octree) 30002, a surface approximation analyzer (Analyze surface approximation) 30003, an arithmetic encoder (Arithmetic encode) 30004, a geometry reconstructor (Reconstruct geometry) 30005, a color transformer (Transform colors) 30006, an attribute transformer (Transfer attributes) 30007, a RAHT transformer 30008, an LOD generator (Generated LOD) 30009, a lifting transformer (Lifting) 30010, a coefficient quantizer (Quantize coefficients) 30011, and/or an arithmetic encoder (Arithmetic encode) 30012. In the point cloud encoder of FIG. 3, the coordinate transformer 30000, the quantizer 30001, the octree analyzer 30002, the surface approximation analyzer 30003, the arithmetic encoder 30004, and the geometry reconstructor 30005 may be grouped together and referred to as a geometry encoder. The color transformer 30006, the attribute transformer 30007, the RAHT transformer 30008, the LOD generator 30009, the lifting transformer 30010, the coefficient quantizer 30011, and/or the arithmetic encoder 30012 may be grouped together and referred to as an attribute encoder.

The coordinate transformer 30000, the quantizer 30001, the octree analyzer 30002, the surface approximation analyzer 30003, the arithmetic encoder 30004, and the geometry reconstructor 30005 may perform geometry encoding. The geometry encoding according to the embodiments may include octree geometry coding, predictive tree geometry coding, direct coding, trisoup geometry encoding, and entropy encoding. The direct coding and trisoup geometry encoding are applied selectively or in combination. The geometry encoding is not limited to the above-described example.

As shown in the figure, the coordinate transformer 30000 according to the embodiments receives positions and transforms the same into coordinates. For example, the positions may be transformed into position information in a three-dimensional space (e.g., a three-dimensional space represented by an XYZ coordinate system). The position information in the three-dimensional space according to the embodiments may be referred to as geometry information.

The quantizer 30001 according to the embodiments quantizes the geometry. For example, the quantizer 30001 may quantize the points based on a minimum position value of all points (e.g., a minimum value on each of the X, Y, and Z axes). The quantizer 30001 performs a quantization operation of multiplying the difference between the minimum position value and the position value of each point by a preset quantization scale value and then finding the nearest integer value by rounding the value obtained through the multiplication. Thus, one or more points may have the same quantized position (or position value). The quantizer 30001 according to the embodiments performs voxelization based on the quantized positions to reconstruct quantized points. As in the case of a pixel, which is the minimum unit containing 2D image/video information, points of point cloud content (or 3D point cloud video) according to the embodiments may be included in one or more voxels. The term voxel, which is a compound of volume and pixel, refers to a 3D cubic space generated when a 3D space is divided into units (unit=1.0) based on the axes representing the 3D space (e.g., X-axis, Y-axis, and Z-axis). The quantizer 30001 may match groups of points in the 3D space with voxels. According to embodiments, one voxel may include only one point. According to embodiments, one voxel may include one or more points. In order to express one voxel as one point, the position of the center of a voxel may be set based on the positions of one or more points included in the voxel. In this case, attributes of all positions included in one voxel may be combined and assigned to the voxel.

The octree analyzer 30002 according to the embodiments performs octree geometry coding (or octree coding) to present voxels in an octree structure. The octree structure represents points matched with voxels, based on the octal tree structure.

The surface approximation analyzer 30003 according to the embodiments may analyze and approximate the octree. The octree analysis and approximation according to the embodiments is a process of analyzing a region containing a plurality of points to efficiently provide octree and voxelization.

The arithmetic encoder 30004 according to the embodiments performs entropy encoding on the octree and/or the approximated octree. For example, the encoding scheme includes arithmetic encoding. As a result of the encoding, a geometry bitstream is generated.

The color transformer 30006, the attribute transformer 30007, the RAHT transformer 30008, the LOD generator 30009, the lifting transformer 30010, the coefficient quantizer 30011, and/or the arithmetic encoder 30012 perform attribute encoding. As described above, one point may have one or more attributes. The attribute encoding according to the embodiments is equally applied to the attributes that one point has. However, when an attribute (e.g., color) includes one or more elements, attribute encoding is independently applied to each element. The attribute encoding according to the embodiments includes color transform coding, attribute transform coding, region adaptive hierarchical transform (RAHT) coding, interpolation-based hierarchical nearest-neighbor prediction (prediction transform) coding, and interpolation-based hierarchical nearest-neighbor prediction with an update/lifting step (lifting transform) coding. Depending on the point cloud content, the RAHT coding, the prediction transform coding and the lifting transform coding described above may be selectively used, or a combination of one or more of the coding schemes may be used. The attribute encoding according to the embodiments is not limited to the above-described example.

The color transformer 30006 according to the embodiments performs color transform coding of transforming color values (or textures) included in the attributes. For example, the color transformer 30006 may transform the format of color information (for example, from RGB to YCbCr). The operation of the color transformer 30006 according to embodiments may be optionally applied according to the color values included in the attributes.

The geometry reconstructor 30005 according to the embodiments reconstructs (decompresses) the octree and/or the approximated octree. The geometry reconstructor 30005 reconstructs the octree/voxels based on the result of analyzing the distribution of points. The reconstructed octree/voxels may be referred to as reconstructed geometry (restored geometry).

The attribute transformer 30007 according to the embodiments performs attribute transformation to transform the attributes based on the reconstructed geometry and/or the positions on which geometry encoding is not performed. As described above, since the attributes are dependent on the geometry, the attribute transformer 30007 may transform the attributes based on the reconstructed geometry information. For example, based on the position value of a point included in a voxel, the attribute transformer 30007 may transform the attribute of the point at the position. As described above, when the position of the center of a voxel is set based on the positions of one or more points included in the voxel, the attribute transformer 30007 transforms the attributes of the one or more points. When the trisoup geometry encoding is performed, the attribute transformer 30007 may transform the attributes based on the trisoup geometry encoding.

The attribute transformer 30007 may perform the attribute transformation by calculating the average of attributes or attribute values of neighboring points (e.g., color or reflectance of each point) within a specific position/radius from the position (or position value) of the center of each voxel. The attribute transformer 30007 may apply a weight according to the distance from the center to each point in calculating the average. Accordingly, each voxel has a position and a calculated attribute (or attribute value).

The attribute transformer 30007 may search for neighboring points existing within a specific position/radius from the position of the center of each voxel based on the K-D tree or the Morton code. The K-D tree is a binary search tree and supports a data structure capable of managing points based on the positions such that nearest neighbor search (NNS) can be performed quickly. The Morton code is generated by presenting coordinates (e.g., (x, y, z)) representing 3D positions of all points as bit values and mixing the bits. For example, when the coordinates representing the position of a point are (5, 9, 1), the bit values for the coordinates are (0101, 1001, 0001). Mixing the bit values according to the bit index in order of z, y, and x yields 010001000111. This value is expressed as a decimal number of 1095. That is, the Morton code value of the point having coordinates (5, 9, 1) is 1095. The attribute transformer 30007 may order the points based on the Morton code values and perform NNS through a depth-first traversal process. After the attribute transformation operation, the K-D tree or the Morton code is used when the NNS is needed in another transformation process for attribute coding.

As shown in the figure, the transformed attributes are input to the RAHT transformer 30008 and/or the LOD generator 30009.

The RAHT transformer 30008 according to the embodiments performs RAHT coding for predicting attribute information based on the reconstructed geometry information. For example, the RAHT transformer 30008 may predict attribute information of a node at a higher level in the octree based on the attribute information associated with a node at a lower level in the octree.

The LOD generator 30009 according to the embodiments generates a level of detail (LOD) to perform prediction transform coding. The LOD according to the embodiments is a degree of detail of point cloud content. As the LOD value decrease, it indicates that the detail of the point cloud content is degraded. As the LOD value increases, it indicates that the detail of the point cloud content is enhanced. Points may be classified by the LOD.

The lifting transformer 30010 according to the embodiments performs lifting transform coding of transforming the attributes a point cloud based on weights. As described above, lifting transform coding may be optionally applied.

The coefficient quantizer 30011 according to the embodiments quantizes the attribute-coded attributes based on coefficients.

The arithmetic encoder 30012 according to the embodiments encodes the quantized attributes based on arithmetic coding.

Although not shown in the figure, the elements of the point cloud encoder of FIG. 3 may be implemented by hardware including one or more processors or integrated circuits configured to communicate with one or more memories included in the point cloud providing device, software, firmware, or a combination thereof. The one or more processors may perform at least one of the operations and/or functions of the elements of the point cloud encoder of FIG. 3 described above. Additionally, the one or more processors may operate or execute a set of software programs and/or instructions for performing the operations and/or functions of the elements of the point cloud encoder of FIG. 3. The one or more memories according to the embodiments may include a high speed random access memory, or include a non-volatile memory (e.g., one or more magnetic disk storage devices, flash memory devices, or other non-volatile solid-state memory devices).

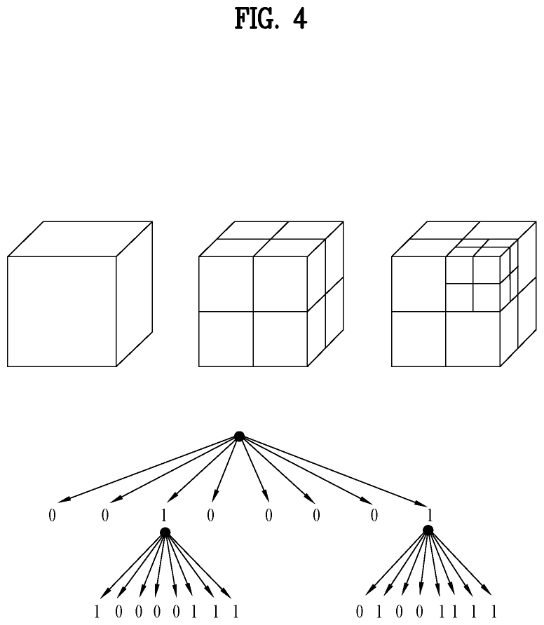

FIG. 4 shows an example of an octree and occupancy code according to embodiments.

As described with reference to FIGS. 1 to 3, the point cloud content providing system (point cloud video encoder 10002) or the point cloud encoder (e.g., the octree analyzer 30002) performs octree geometry coding (or octree coding) based on an octree structure to efficiently manage the region and/or position of the voxel.

The upper part of FIG. 4 shows an octree structure. The 3D space of the point cloud content according to the embodiments is represented by axes (e.g., X-axis, Y-axis, and Z-axis) of the coordinate system. The octree structure is created by recursive subdividing of a cubical axis-aligned bounding box defined by two poles (0, 0, 0) and (2^{d}, 2^{d}, 2^{d}). Here, 2d may be set to a value constituting the smallest bounding box surrounding all points of the point cloud content (or point cloud video). Here, d denotes the depth of the octree. The value of d is determined in the following equation. In the following equation, (x^{int}ₙ, y^{int}ₙ, z^{int}ₙ) denotes the positions (or position values) of quantized points.

$$d = Ceil ( Log 2 ( Max ( {x}_{n}^{int} , {y}_{n}^{int} , {z}_{n}^{int} , n = 1 , … , N ) + 1 ) )$$

As shown in the middle of the upper part of FIG. 4, the entire 3D space may be divided into eight spaces according to partition. Each divided space is represented by a cube with six faces. As shown in the upper right of FIG. 4, each of the eight spaces is divided again based on the axes of the coordinate system (e.g., X-axis, Y-axis, and Z-axis). Accordingly, each space is divided into eight smaller spaces. The divided smaller space is also represented by a cube with six faces. This partitioning scheme is applied until the leaf node of the octree becomes a voxel.

The lower part of FIG. 4 shows an octree occupancy code. The occupancy code of the octree is generated to indicate whether each of the eight divided spaces generated by dividing one space contains at least one point. Accordingly, a single occupancy code is represented by eight child nodes. Each child node represents the occupancy of a divided space, and the child node has a value in 1 bit. Accordingly, the occupancy code is represented as an 8-bit code. That is, when at least one point is contained in the space corresponding to a child node, the node is assigned a value of 1. When no point is contained in the space corresponding to the child node (the space is empty), the node is assigned a value of 0. Since the occupancy code shown in FIG. 4 is 00100001, it indicates that the spaces corresponding to the third child node and the eighth child node among the eight child nodes each contain at least one point. As shown in the figure, each of the third child node and the eighth child node has eight child nodes, and the child nodes are represented by an 8-bit occupancy code. The figure shows that the occupancy code of the third child node is 10000111, and the occupancy code of the eighth child node is 01001111. The point cloud encoder (e.g., the arithmetic encoder 30004) according to the embodiments may perform entropy encoding on the occupancy codes. In order to increase the compression efficiency, the point cloud encoder may perform intra/inter-coding on the occupancy codes. The reception device (e.g., the reception device 10004 or the point cloud video decoder 10006) according to the embodiments reconstructs the octree based on the occupancy codes.

The point cloud encoder (e.g., the point cloud encoder of FIG. 4 or the octree analyzer 30002) according to the embodiments may perform voxelization and octree coding to store the positions of points. However, points are not always evenly distributed in the 3D space, and accordingly there may be a specific region in which fewer points are present. Accordingly, it is inefficient to perform voxelization for the entire 3D space. For example, when a specific region contains few points, voxelization does not need to be performed in the specific region.

Accordingly, for the above-described specific region (or a node other than the leaf node of the octree), the point cloud encoder according to the embodiments may skip voxelization and perform direct coding to directly code the positions of points included in the specific region. The coordinates of a direct coding point according to the embodiments are referred to as direct coding mode (DCM). The point cloud encoder according to the embodiments may also perform trisoup geometry encoding, which is to reconstruct the positions of the points in the specific region (or node) based on voxels, based on a surface model. The trisoup geometry encoding is geometry encoding that represents an object as a series of triangular meshes. Accordingly, the point cloud decoder may generate a point cloud from the mesh surface. The direct coding and trisoup geometry encoding according to the embodiments may be selectively performed. In addition, the direct coding and trisoup geometry encoding according to the embodiments may be performed in combination with octree geometry coding (or octree coding).

To perform direct coding, the option to use the direct mode for applying direct coding should be activated. A node to which direct coding is to be applied is not a leaf node, and points less than a threshold should be present within a specific node. In addition, the total number of points to which direct coding is to be applied should not exceed a preset threshold. When the conditions above are satisfied, the point cloud encoder (or the arithmetic encoder 30004) according to the embodiments may perform entropy coding on the positions (or position values) of the points.

The point cloud encoder (e.g., the surface approximation analyzer 30003) according to the embodiments may determine a specific level of the octree (a level less than the depth d of the octree), and the surface model may be used staring with that level to perform trisoup geometry encoding to reconstruct the positions of points in the region of the node based on voxels (Trisoup mode). The point cloud encoder according to the embodiments may specify a level at which trisoup geometry encoding is to be applied. For example, when the specific level is equal to the depth of the octree, the point cloud encoder does not operate in the trisoup mode. In other words, the point cloud encoder according to the embodiments may operate in the trisoup mode only when the specified level is less than the value of depth of the octree. The 3D cube region of the nodes at the specified level according to the embodiments is called a block. One block may include one or more voxels. The block or voxel may correspond to a brick. Geometry is represented as a surface within each block. The surface according to embodiments may intersect with each edge of a block at most once.

One block has 12 edges, and accordingly there are at least 12 intersections in one block. Each intersection is called a vertex (or apex). A vertex present along an edge is detected when there is at least one occupied voxel adjacent to the edge among all blocks sharing the edge. The occupied voxel according to the embodiments refers to a voxel containing a point. The position of the vertex detected along the edge is the average position along the edge of all voxels adjacent to the edge among all blocks sharing the edge.

Once the vertex is detected, the point cloud encoder according to the embodiments may perform entropy encoding on the starting point (x, y, z) of the edge, the direction vector (Δx, Δy, Δz) of the edge, and the vertex position value (relative position value within the edge). When the trisoup geometry encoding is applied, the point cloud encoder according to the embodiments (e.g., the geometry reconstructor 30005) may generate restored geometry (reconstructed geometry) by performing the triangle reconstruction, up-sampling, and voxelization processes.

The vertices positioned at the edge of the block determine a surface that passes through the block. The surface according to the embodiments is a non-planar polygon. In the triangle reconstruction process, a surface represented by a triangle is reconstructed based on the starting point of the edge, the direction vector of the edge, and the position values of the vertices. The triangle reconstruction process is performed by: i) calculating the centroid value of each vertex, ii) subtracting the center value from each vertex value, and iii) estimating the sum of the squares of the values obtained by the subtraction.

$$\text{?} [ \begin{matrix}{μ}_{x} \\ {μ}_{y} \\ {μ}_{z}\end{matrix} ] = \frac{1}{n} {\sum }_{i = 1}^{n} [ \begin{matrix}{x}_{i} \\ {y}_{i} \\ {z}_{i}\end{matrix} ] \text{?} [ \begin{matrix}{\overline{x}}_{i} \\ {y}_{i} \\ {z}_{i}\end{matrix} ] - [ \begin{matrix}{μ}_{x} \\ {μ}_{y} \\ {μ}_{z}\end{matrix} ] \text{?} [ \begin{matrix}{σ}_{x}^{2} \\ {σ}_{y}^{2} \\ {σ}_{z}^{2}\end{matrix} ] = {\sum }_{i = 1}^{n} [ \begin{matrix}{\overline{x}}_{i}^{2} \\ {\overline{y}}_{i}^{2} \\ {\overline{z}}_{i}^{2}\end{matrix} ]$$

The minimum value of the sum is estimated, and the projection process is performed according to the axis with the minimum value. For example, when the element x is the minimum, each vertex is projected on the x-axis with respect to the center of the block, and projected on the (y, z) plane. When the values obtained through projection on the (y, z) plane are (ai, bi), the value of 0 is estimated through a tan2(bi, ai), and the vertices are ordered based on the value of 0. The table 1 below shows a combination of vertices for creating a triangle according to the number of the vertices. The vertices are ordered from 1 to n. The table 1 below shows that for four vertices, two triangles may be constructed according to combinations of vertices. The first triangle may consist of vertices 1, 2, and 3 among the ordered vertices, and the second triangle may consist of vertices 3, 4, and 1 among the ordered vertices.

TABLE 1
Triangles formed from vertices ordered 1, . . . , n

| n | Triangles |
|---|---|
| 3 | (1, 2, 3) |
| 4 | (1, 2, 3), (3, 4, 1) |
| 5 | (1, 2, 3), (3, 4, 5), (5, 1, 3) |
| 6 | (1, 2, 3), (3, 4, 5), (5, 6, 1), (1, 3, 5) |
| 7 | (1, 2, 3), (3, 4, 5), (5, 6, 7), (7, 1, 3), (3, 5, 7) |
| 8 | (1, 2, 3), (3, 4, 5), (5, 6, 7), (7, 8, 1), (1, 3, 5), (5, 7, 1) |
| 9 | (1, 2, 3), (3, 4, 5), (5, 6, 7), (7, 8, 9), (9, 1, 3), (3, 5, 7), (7, 9, 3) |
| 10 | (1, 2, 3), (3, 4, 5), (5, 6, 7), (7, 8, 9), (9, 10, 1), (1, 3, 5), (5, 7, 9), (9, 1, 5) |
| 11 | (1, 2, 3), (3, 4, 5), (5, 6, 7), (7, 8, 9), (9, 10, 11), (11, 1, 3), (3, 5, 7), (7, 9, 11), (11, 3, 7) |
| 12 | (1, 2, 3), (3, 4, 5), (5, 6, 7), (7, 8, 9), (9, 10, 11), (11, 12, 1), (1, 3, 5), (5, 7, 9), (9, 11, 1), |
| | (1, 5, 9) |

The upsampling process is performed to add points in the middle along the edge of the triangle and perform voxelization. The added points are generated based on the upsampling factor and the width of the block. The added points are called refined vertices. The point cloud encoder according to the embodiments may voxelize the refined vertices. In addition, the point cloud encoder may perform attribute encoding based on the voxelized positions (or position values).

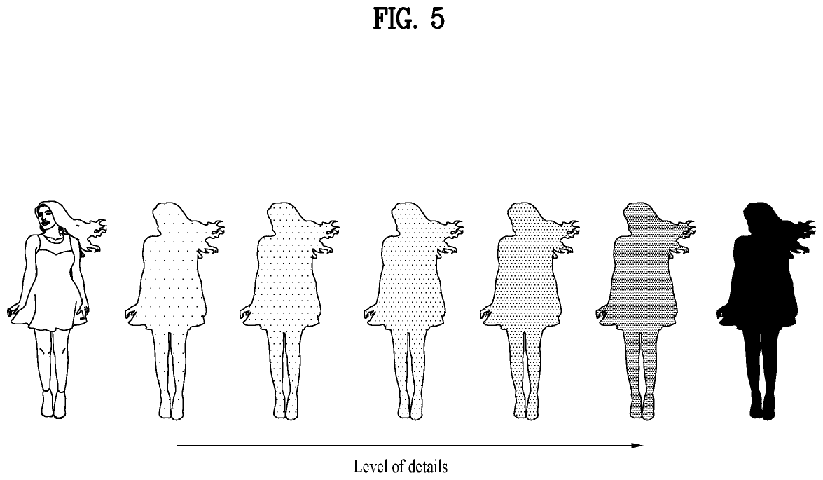

FIG. 5 illustrates an example of point configuration in each LOD according to embodiments.

As described with reference to FIGS. 1 to 4, encoded geometry is reconstructed (decompressed) before attribute encoding is performed. When direct coding is applied, the geometry reconstruction operation may include changing the placement of direct coded points (e.g., placing the direct coded points in front of the point cloud data). When trisoup geometry encoding is applied, the geometry reconstruction process is performed through triangle reconstruction, up-sampling, and voxelization. Since the attribute depends on the geometry, attribute encoding is performed based on the reconstructed geometry.

The point cloud encoder (e.g., the LOD generator 30009) may classify (or reorganize) points by LOD. The figure shows the point cloud content corresponding to LODs. The leftmost picture in the figure represents original point cloud content. The second picture from the left of the figure represents distribution of the points in the lowest LOD, and the rightmost picture in the figure represents distribution of the points in the highest LOD. That is, the points in the lowest LOD are sparsely distributed, and the points in the highest LOD are densely distributed. That is, as the LOD rises in the direction pointed by the arrow indicated at the bottom of the figure, the space (or distance) between points is narrowed.

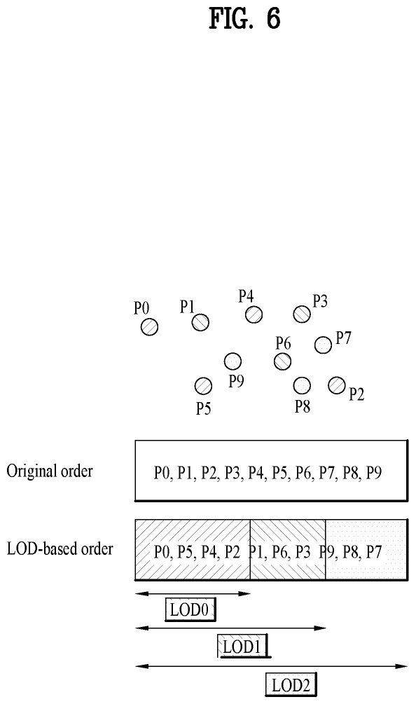

FIG. 6 illustrates an example of point configuration for each LOD according to embodiments.

As described with reference to FIGS. 1 to 5, the point cloud content providing system, or the point cloud encoder (e.g., the point cloud video encoder 10002, the point cloud encoder of FIG. 3, or the LOD generator 30009) may generates an LOD. The LOD is generated by reorganizing the points into a set of refinement levels according to a set LOD distance value (or a set of Euclidean distances). The LOD generation process is performed not only by the point cloud encoder, but also by the point cloud decoder.

The upper part of FIG. 6 shows examples (P0 to P9) of points of the point cloud content distributed in a 3D space. In FIG. 6, the original order represents the order of points P0 to P9 before LOD generation. In FIG. 6, the LOD based order represents the order of points according to the LOD generation. Points are reorganized by LOD. Also, a high LOD contains the points belonging to lower LODs. As shown in FIG. 6, LOD0 contains P0, P5, P4 and P2. LOD1 contains the points of LOD0, P1, P6 and P3. LOD2 contains the points of LOD0, the points of LOD1, P9, P8 and P7.

As described with reference to FIG. 3, the point cloud encoder according to the embodiments may perform prediction transform coding, lifting transform coding, and RAHT transform coding selectively or in combination.

The point cloud encoder according to the embodiments may generate a predictor for points to perform prediction transform coding for setting a predicted attribute (or predicted attribute value) of each point. That is, N predictors may be generated for N points. The predictor according to the embodiments may calculate a weight (=1/distance) based on the LOD value of each point, indexing information about neighboring points present within a set distance for each LOD, and a distance to the neighboring points.

The predicted attribute (or attribute value) according to the embodiments is set to the average of values obtained by multiplying the attributes (or attribute values) (e.g., color, reflectance, etc.) of neighbor points set in the predictor of each point by a weight (or weight value) calculated based on the distance to each neighbor point. The point cloud encoder according to the embodiments (e.g., the coefficient quantizer 30011) may quantize and inversely quantize the residuals (which may be called residual attributes, residual attribute values, attribute prediction residuals, or the like) obtained by subtracting a predicted attribute (or attribute value) of each point from the attribute (attribute value) of each point. The quantization process is shown in Tables 2 and 3 below.

TABLE 2

int PCCQuantization(int value, int quantStep) {
if( value >=0) {
return floor(value / quantStep + 1.0 / 3.0);
} else {
return -floor(-value / quantStep + 1.0 / 3.0);
}
}

TABLE 3

int PCCInverseQuantization(int value, int quantStep) {
if( quantStep ==0) {
return value;
} else {
return value * quantStep;
}
}

When the predictor of each point has neighbor points, the point cloud encoder (e.g., the arithmetic encoder 30012) according to the embodiments may perform entropy coding on the quantized and inversely quantized residual values as described above.

When the predictor of each point has no neighbor point, the point cloud encoder according to the embodiments (e.g., the arithmetic encoder 30012) may perform entropy coding on the attributes of the corresponding point without performing the above-described operation. The point cloud encoder according to the embodiments (e.g., the lifting transformer 30010) may generate a predictor of each point, set the calculated LOD and register neighbor points in the predictor, and set weights according to the distances to neighbor points to perform lifting transform coding. The lifting transform coding according to the embodiments is similar to the above-described prediction transform coding, but differs therefrom in that weights are cumulatively applied to attribute values. The process of cumulatively applying weights to the attribute values according to embodiments is configured as follows.

1) Create an array Quantization Weight (QW) for storing the weight value of each point. The initial value of all elements of QW is 1.0. Multiply the QW values of the predictor indexes of the neighbor nodes registered in the predictor by the weight of the predictor of the current point, and add the values obtained by the multiplication.

2) Lift prediction process: Subtract the value obtained by multiplying the attribute value of the point by the weight from the existing attribute value to calculate a predicted attribute value.

3) Create temporary arrays called updateweight and update and initialize the temporary arrays to zero.

4) Cumulatively add the weights calculated by multiplying the weights calculated for all predictors by a weight stored in the QW corresponding to a predictor index to the updateweight array as indexes of neighbor nodes. Cumulatively add, to the update array, a value obtained by multiplying the attribute value of the index of a neighbor node by the calculated weight.

5) Lift update process: Divide the attribute values of the update array for all predictors by the weight value of the updateweight array of the predictor index, and add the existing attribute value to the values obtained by the division.

6) Calculate predicted attributes by multiplying the attribute values updated through the lift update process by the weight updated through the lift prediction process (stored in the QW) for all predictors. The point cloud encoder (e.g., coefficient quantizer 30011) according to the embodiments quantizes the predicted attribute values. In addition, the point cloud encoder (e.g., the arithmetic encoder 30012) performs entropy coding on the quantized attribute values.

The point cloud encoder (for example, the RAHT transformer 30008) according to the embodiments may perform RAHT transform coding in which attributes of nodes of a higher level are predicted using the attributes associated with nodes of a lower level in the octree. RAHT transform coding is an example of attribute intra coding through an octree backward scan. The point cloud encoder according to the embodiments scans the entire region from the voxel and repeats the merging process of merging the voxels into a larger block at each step until the root node is reached. The merging process according to the embodiments is performed only on the occupied nodes. The merging process is not performed on the empty node. The merging process is performed on an upper node immediately above the empty node.

The equation below represents a RAHT transformation matrix. In the equation, g₁_{_{x,y,z}} denotes the average attribute value of voxels at level 1. g₁_{_{x,y,z}} may be calculated based on g₁₊₁_{_{2x,y,z}} and g_{1+1 2X+1,y,z}. The weights for g₁_{_{2x,y,z}} and g₁ _{_{2x+1,y,z}} are w1=w₁_{_{2x,y,z}} and w2=w₁_{_{2x+1,y,z}}.

$$[ \begin{matrix}{g}_{l − {1}_{x , y , z}} \\ {h}_{l − {1}_{x , y , z}}\end{matrix} ] = {T}_{w 1 w 2} [ \begin{matrix}{g}_{{l}_{2 x , y , z}} \\ {g}_{{l}_{2 x + 1 , y , z}}\end{matrix} ] , \text{} {T}_{1 w 2} = \frac{1}{\sqrt{w 1 + w 2}} [ \begin{matrix}\sqrt{w 1} & \sqrt{w 2} \\ − \sqrt{w 2} & \sqrt{w 1}\end{matrix} ]$$

Here, gₗ₋₁_{_{x,y,z}} is a low-pass value and is used in the merging process at the next higher level. hₗ₋₁ _{_{x,y,z}} denotes high-pass coefficients. The high.0000000000-pass coefficients at each step are quantized and subjected to entropy coding (e.g., encoding by the arithmetic encoder 30012). The weights are calculated as wₗ_{_{−1 x,y,z}}=wₗ_{_{2x,y,z}}+wₗ_{_{2x+1,y,Z}}. The root node is created through the g₁_{_{0,0,0}} and g₁_{_{0,0,1}} as follows.

$$⌈ \begin{matrix}gDC \\ {h}_{{0}_{0 , 0 , 0}}\end{matrix} ⌉ = {T}_{w 1000 w 1001} ⌈ \begin{matrix}{g}_{{1}_{0 , 0 , 0 z}} \\ {g}_{{1}_{0 , 0 , 1}}\end{matrix} ⌉$$

The value of gDC is also quantized and subjected to entropy coding like the high-pass coefficients.

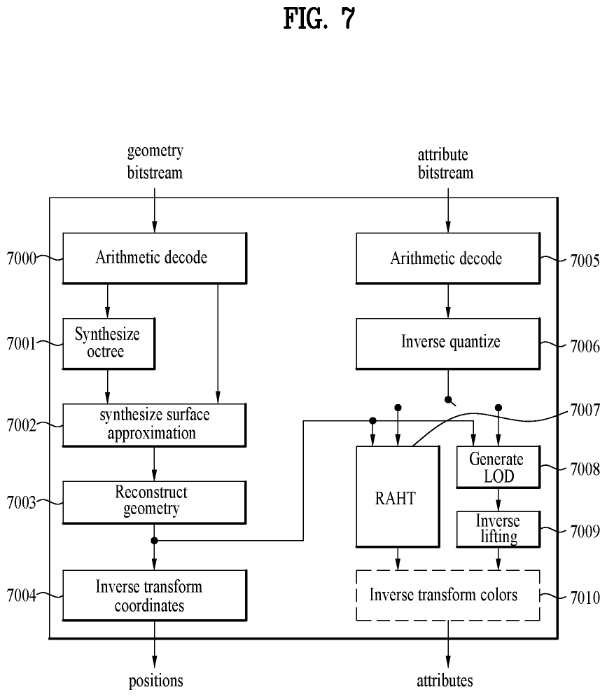

FIG. 7 illustrates a point cloud decoder according to embodiments.

The point cloud decoder illustrated in FIG. 7 is an example of the point cloud decoder and may perform a decoding operation, which is a reverse process to the encoding operation of the point cloud encoder illustrated in FIGS. 1 to 6.

As described with reference to FIGS. 1 and 6, the point cloud decoder may perform geometry decoding and attribute decoding. The geometry decoding is performed before the attribute decoding.

The point cloud decoder according to the embodiments includes an arithmetic decoder (Arithmetic decode) 7000, an octree synthesizer (Synthesize octree) 7001, a surface approximation synthesizer (Synthesize surface approximation) 7002, and a geometry reconstructor (Reconstruct geometry) 7003, a coordinate inverse transformer (Inverse transform coordinates) 7004, an arithmetic decoder (Arithmetic decode) 7005, an inverse quantizer (Inverse quantize) 7006, a RAHT transformer 7007, an LOD generator (Generate LOD) 7008, an inverse lifter (inverse lifting) 7009, and/or a color inverse transformer (Inverse transform colors) 7010.

The arithmetic decoder 7000, the octree synthesizer 7001, the surface approximation synthesizer 7002, and the geometry reconstructor 7003, and the coordinate inverse transformer 7004 may perform geometry decoding. The geometry decoding according to the embodiments may include direct decoding and trisoup geometry decoding. The direct coding and trisoup geometry decoding are selectively applied. The geometry decoding is not limited to the above-described example, and is performed as a reverse process to the geometry encoding described with reference to FIGS. 1 to 6.

The arithmetic decoder 7000 according to the embodiments decodes the received geometry bitstream based on the arithmetic coding. The operation of the arithmetic decoder 7000 corresponds to the reverse process to the arithmetic encoder 30004.

The octree synthesizer 7001 according to the embodiments may generate an octree by acquiring an occupancy code from the decoded geometry bitstream (or information on the geometry secured as a result of decoding). The occupancy code is configured as described in detail with reference to FIGS. 1 to 6.

When the trisoup geometry encoding is applied, the surface approximation synthesizer 7002 according to the embodiments may synthesize a surface based on the decoded geometry and/or the generated octree.

The geometry reconstructor 7003 according to the embodiments may regenerate geometry based on the surface and/or the decoded geometry. As described with reference to FIGS. 1 to 9, direct coding and trisoup geometry encoding are selectively applied. Accordingly, the geometry reconstructor 7003 directly imports and adds position information about the points to which direct coding is applied. When the trisoup geometry encoding is applied, the geometry reconstructor 7003 may reconstruct the geometry by performing the reconstruction operations of the geometry reconstructor 30005, for example, triangle reconstruction, up-sampling, and voxelization. Details are the same as those described with reference to FIG. 6, and thus description thereof is omitted. The reconstructed geometry may include a point cloud picture or frame that does not contain attributes.

The coordinate inverse transformer 7004 according to the embodiments may acquire positions of the points by transforming the coordinates based on the reconstructed geometry.

The arithmetic decoder 7005, the inverse quantizer 7006, the RAHT transformer 7007, the LOD generator 7008, the inverse lifter 7009, and/or the color inverse transformer 7010 may perform the attribute decoding. The attribute decoding according to the embodiments includes region adaptive hierarchical transform (RAHT) decoding, interpolation-based hierarchical nearest-neighbor prediction (prediction transform) decoding, and interpolation-based hierarchical nearest-neighbor prediction with an update/lifting step (lifting transform) decoding. The three decoding schemes described above may be used selectively, or a combination of one or more decoding schemes may be used. The attribute decoding according to the embodiments is not limited to the above-described example.

The arithmetic decoder 7005 according to the embodiments decodes the attribute bitstream by arithmetic coding.

The inverse quantizer 7006 according to the embodiments inversely quantizes the information about the decoded attribute bitstream or attributes secured as a result of the decoding, and outputs the inversely quantized attributes (or attribute values). The inverse quantization may be selectively applied based on the attribute encoding of the point cloud encoder.

According to embodiments, the RAHT transformer 7007, the LOD generator 7008, and/or the inverse lifter 7009 may process the reconstructed geometry and the inversely quantized attributes. As described above, the RAHT transformer 7007, the LOD generator 7008, and/or the inverse lifter 7009 may selectively perform a decoding operation corresponding to the encoding of the point cloud encoder.

The color inverse transformer 7010 according to the embodiments performs inverse transform coding to inversely transform a color value (or texture) included in the decoded attributes. The operation of the color inverse transformer 7010 may be selectively performed based on the operation of the color transformer 30006 of the point cloud encoder.

Although not shown in the figure, the elements of the point cloud decoder of FIG. 7 may be implemented by hardware including one or more processors or integrated circuits configured to communicate with one or more memories included in the point cloud providing device, software, firmware, or a combination thereof. The one or more processors may perform at least one or more of the operations and/or functions of the elements of the point cloud decoder of FIG. 7 described above. Additionally, the one or more processors may operate or execute a set of software programs and/or instructions for performing the operations and/or functions of the elements of the point cloud decoder of FIG. 7.

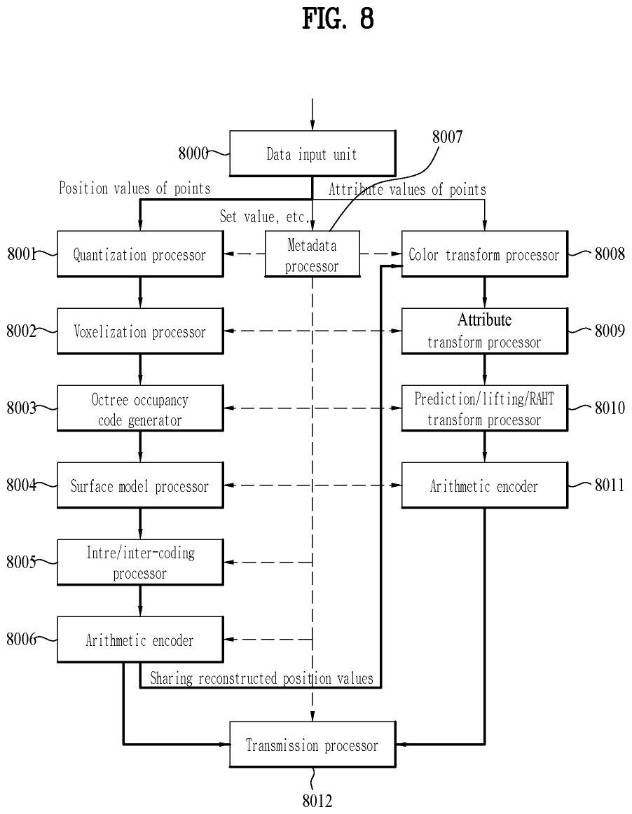

FIG. 8 illustrates a transmission device according to embodiments.

The transmission device shown in FIG. 8 is an example of the transmission device 10000 of FIG. 1 (or the point cloud encoder of FIG. 3). The transmission device illustrated in FIG. 8 may perform one or more of the operations and methods the same as or similar to those of the point cloud encoder described with reference to FIGS. 1 to 6. The transmission device according to the embodiments may include a data input unit 8000, a quantization processor 8001, a voxelization processor 8002, an octree occupancy code generator 8003, a surface model processor 8004, an intra/inter-coding processor 8005, an arithmetic coder 8006, a metadata processor 8007, a color transform processor 8008, an attribute transform processor 8009, a prediction/lifting/RAHT transform processor 8010, an arithmetic coder 8011 and/or a transmission processor 8012.

The data input unit 8000 according to the embodiments receives or acquires point cloud data. The data input unit 8000 may perform an operation and/or acquisition method the same as or similar to the operation and/or acquisition method of the point cloud video acquisition unit 10001 (or the acquisition process 20000 described with reference to FIG. 2).

The data input unit 8000, the quantization processor 8001, the voxelization processor 8002, the octree occupancy code generator 8003, the surface model processor 8004, the intra/inter-coding processor 8005, and the arithmetic coder 8006 perform geometry encoding. The geometry encoding according to the embodiments is the same as or similar to the geometry encoding described with reference to FIGS. 1 to 9, and thus a detailed description thereof is omitted.

The quantization processor 8001 according to the embodiments quantizes geometry (e.g., position values of points). The operation and/or quantization of the quantization processor 8001 is the same as or similar to the operation and/or quantization of the quantizer 30001 described with reference to FIG. 3. Details are the same as those described with reference to FIGS. 1 to 9.

The voxelization processor 8002 according to the embodiments voxelizes the quantized position values of the points. The voxelization processor 8002 may perform an operation and/or process the same or similar to the operation and/or the voxelization process of the quantizer 30001 described with reference to FIG. 3. Details are the same as those described with reference to FIGS. 1 to 6.

The octree occupancy code generator 8003 according to the embodiments performs octree coding on the voxelized positions of the points based on an octree structure. The octree occupancy code generator 8003 may generate an occupancy code. The octree occupancy code generator 8003 may perform an operation and/or method the same as or similar to the operation and/or method of the point cloud encoder (or the octree analyzer 30002) described with reference to FIGS. 3 and 4. Details are the same as those described with reference to FIGS. 1 to 6.

The surface model processor 8004 according to the embodiments may perform trisoup geometry encoding based on a surface model to reconstruct the positions of points in a specific region (or node) on a voxel basis. The surface model processor 8004 may perform an operation and/or method the same as or similar to the operation and/or method of the point cloud encoder (e.g., the surface approximation analyzer 30003) described with reference to FIG. 3. Details are the same as those described with reference to FIGS. 1 to 6.

The intra/inter-coding processor 8005 according to the embodiments may perform intra/inter-coding on point cloud data. The intra/inter-coding processor 8005 may perform coding the same as or similar to the intra/inter-coding. According to embodiments, the intra/inter-coding processor 8005 may be included in the arithmetic coder 8006.

The arithmetic coder 8006 according to the embodiments performs entropy encoding on an octree of the point cloud data and/or an approximated octree. For example, the encoding scheme includes arithmetic encoding. The arithmetic coder 8006 performs an operation and/or method the same as or similar to the operation and/or method of the arithmetic encoder 30004.

The metadata processor 8007 according to the embodiments processes metadata about the point cloud data, for example, a set value, and provides the same to a necessary processing process such as geometry encoding and/or attribute encoding. Also, the metadata processor 8007 according to the embodiments may generate and/or process signaling information related to the geometry encoding and/or the attribute encoding. The signaling information according to the embodiments may be encoded separately from the geometry encoding and/or the attribute encoding. The signaling information according to the embodiments may be interleaved.

The color transform processor 8008, the attribute transform processor 8009, the prediction/lifting/RAHT transform processor 8010, and the arithmetic coder 8011 perform the attribute encoding. The attribute encoding according to the embodiments is the same as or similar to the attribute encoding described with reference to FIGS. 1 to 6, and thus a detailed description thereof is omitted.

The color transform processor 8008 according to the embodiments performs color transform coding to transform color values included in attributes. The color transform processor 8008 may perform color transform coding based on the reconstructed geometry. The reconstructed geometry is the same as described with reference to FIGS. 1 to 9. Also, it performs an operation and/or method the same as or similar to the operation and/or method of the color transformer 30006 described with reference to FIG. 3 is performed. A detailed description thereof is omitted.

The attribute transform processor 8009 according to the embodiments performs attribute transformation to transform the attributes based on the reconstructed geometry and/or the positions on which geometry encoding is not performed. The attribute transform processor 8009 performs an operation and/or method the same as or similar to the operation and/or method of the attribute transformer 30007 described with reference to FIG. 3. A detailed description thereof is omitted. The prediction/lifting/RAHT transform processor 8010 according to the embodiments may code the transformed attributes by any one or a combination of RAHT coding, prediction transform coding, and lifting transform coding. The prediction/lifting/RAHT transform processor 8010 performs at least one of the operations the same as or similar to the operations of the RAHT transformer 30008, the LOD generator 30009, and the lifting transformer 30010 described with reference to FIG. 3. In addition, the prediction transform coding, the lifting transform coding, and the RAHT transform coding are the same as those described with reference to FIGS. 1 to 9, and thus a detailed description thereof is omitted.

The arithmetic coder 8011 according to the embodiments may encode the coded attributes based on the arithmetic coding. The arithmetic coder 8011 performs an operation and/or method the same as or similar to the operation and/or method of the arithmetic encoder 30012.

The transmission processor 8012 according to the embodiments may transmit each bitstream containing encoded geometry and/or encoded attributes or metadata information, or transmit one bitstream containing the encoded geometry and/or the encoded attributes and the metadata information. When the encoded geometry and/or the encoded attributes and the metadata information according to the embodiments are configured into one bitstream, the bitstream may include one or more sub-bitstreams. The bitstream according to the embodiments may contain signaling information including a sequence parameter set (SPS) for signaling of a sequence level, a geometry parameter set (GPS) for signaling of geometry information coding, an attribute parameter set (APS) for signaling of attribute information coding, and a tile parameter set (TPS) for signaling of a tile level, and slice data. The slice data may include information about one or more slices. One slice according to embodiments may include one geometry bitstream Geom00 and one or more attribute bitstreams Attr00 and Attr10.

A slice refers to a series of syntax elements representing the entirety or part of a coded point cloud frame.

The TPS according to the embodiments may include information about each tile (e.g., coordinate information and height/size information about a bounding box) for one or more tiles. The geometry bitstream may contain a header and a payload. The header of the geometry bitstream according to the embodiments may contain a parameter set identifier (geom_parameter_set_id), a tile identifier (geom_tile_id) and a slice identifier (geom_slice_id) included in the GPS, and information about the data contained in the payload. As described above, the metadata processor 8007 according to the embodiments may generate and/or process the signaling information and transmit the same to the transmission processor 8012. According to embodiments, the elements to perform geometry encoding and the elements to perform attribute encoding may share data/information with each other as indicated by dotted lines. The transmission processor 8012 according to the embodiments may perform an operation and/or transmission method the same as or similar to the operation and/or transmission method of the transmitter 10003. Details are the same as those described with reference to FIGS. 1 and 2, and thus a description thereof is omitted.

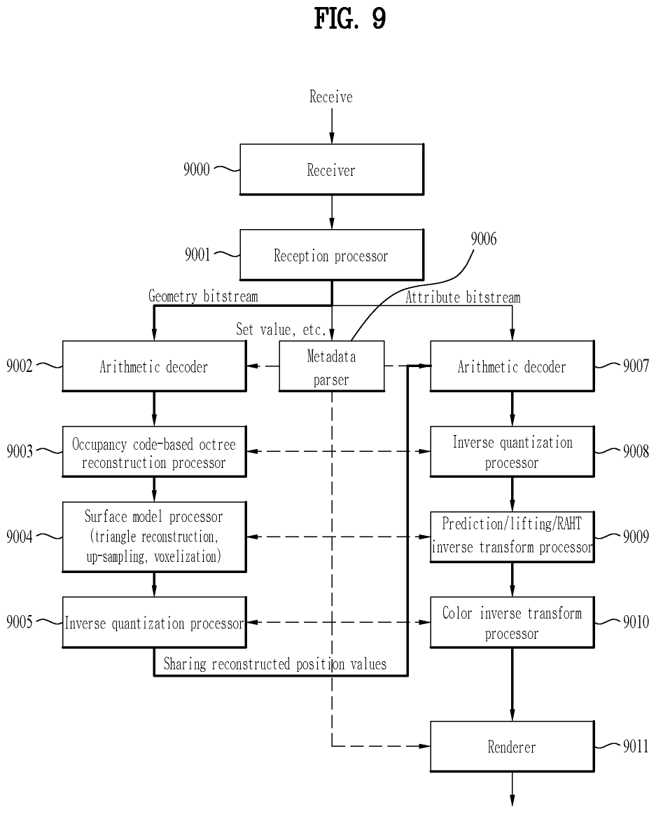

FIG. 9 illustrates a reception device according to embodiments.

The reception device illustrated in FIG. 9 is an example of the reception device 10004 of FIG. 1. The reception device illustrated in FIG. 9 may perform one or more of the operations and methods the same as or similar to those of the point cloud decoder described with reference to FIGS. 1 to 8.

The reception device according to the embodiment may include a receiver 9000, a reception processor 9001, an arithmetic decoder 9002, an occupancy code-based octree reconstruction processor 9003, a surface model processor (triangle reconstruction, up-sampling, voxelization) 9004, an inverse quantization processor 9005, a metadata parser 9006, an arithmetic decoder 9007, an inverse quantization processor 9008, a prediction/lifting/RAHT inverse transform processor 9009, a color inverse transform processor 9010, and/or a renderer 9011. Each element for decoding according to the embodiments may perform a reverse process to the operation of a corresponding element for encoding according to the embodiments.

The receiver 9000 according to the embodiments receives point cloud data. The receiver 9000 may perform an operation and/or reception method the same as or similar to the operation and/or reception method of the receiver 10005 of FIG. 1. The detailed description thereof is omitted.

The reception processor 9001 according to the embodiments may acquire a geometry bitstream and/or an attribute bitstream from the received data. The reception processor 9001 may be included in the receiver 9000.

The arithmetic decoder 9002, the occupancy code-based octree reconstruction processor 9003, the surface model processor 9004, and the inverse quantization processor 905 may perform geometry decoding. The geometry decoding according to embodiments is the same as or similar to the geometry decoding described with reference to FIGS. 1 to 8, and thus a detailed description thereof is omitted.

The arithmetic decoder 9002 according to the embodiments may decode the geometry bitstream based on arithmetic coding. The arithmetic decoder 9002 performs an operation and/or coding the same as or similar to the operation and/or coding of the arithmetic decoder 7000.

The occupancy code-based octree reconstruction processor 9003 according to the embodiments may reconstruct an octree by acquiring an occupancy code from the decoded geometry bitstream (or information about the geometry secured as a result of decoding). The occupancy code-based octree reconstruction processor 9003 performs an operation and/or method the same as or similar to the operation and/or octree generation method of the octree synthesizer 7001. When the trisoup geometry encoding is applied, the surface model processor 9004 according to the embodiments may perform trisoup geometry decoding and related geometry reconstruction (e.g., triangle reconstruction, up-sampling, voxelization) based on the surface model method. The surface model processor 9004 performs an operation the same as or similar to that of the surface approximation synthesizer 7002 and/or the geometry reconstructor 7003.

The inverse quantization processor 9005 according to the embodiments may inversely quantize the decoded geometry.

The metadata parser 9006 according to the embodiments may parse metadata contained in the received point cloud data, for example, a set value. The metadata parser 9006 may pass the metadata to geometry decoding and/or attribute decoding. The metadata is the same as that described with reference to FIG. 8, and thus a detailed description thereof is omitted.

The arithmetic decoder 9007, the inverse quantization processor 9008, the prediction/lifting/RAHT inverse transform processor 9009 and the color inverse transform processor 9010 perform attribute decoding. The attribute decoding is the same as or similar to the attribute decoding described with reference to at least one of FIGS. 1 to 8, and thus a detailed description thereof is omitted.

The arithmetic decoder 9007 according to the embodiments may decode the attribute bitstream by arithmetic coding. The arithmetic decoder 9007 may decode the attribute bitstream based on the reconstructed geometry. The arithmetic decoder 9007 performs an operation and/or coding the same as or similar to the operation and/or coding of the arithmetic decoder 7005.

The inverse quantization processor 9008 according to the embodiments may inversely quantize the decoded attribute bitstream. The inverse quantization processor 9008 performs an operation and/or method the same as or similar to the operation and/or inverse quantization method of the inverse quantizer 7006.

The prediction/lifting/RAHT inverse transform processor 9009 according to the embodiments may process the reconstructed geometry and the inversely quantized attributes.

The prediction/lifting/RAHT inverse transform processor 9009 performs one or more of operations and/or decoding the same as or similar to the operations and/or decoding of the RAHT transformer 7007, the LOD generator 7008, and/or the inverse lifter 7009 of FIG. 7. The color inverse transform processor 9010 according to the embodiments performs inverse transform coding to inversely transform color values (or textures) included in the decoded attributes. The color inverse transform processor 9010 performs an operation and/or inverse transform coding the same as or similar to the operation and/or inverse transform coding of the color inverse transformer 7010 of FIG. 7. The renderer 9011 according to the embodiments may render the point cloud data.

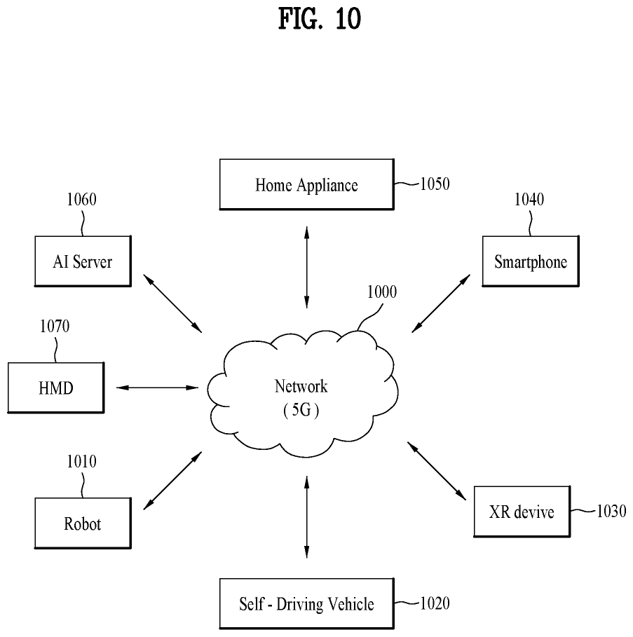

FIG. 10 illustrates an exemplary structure operable in connection with point cloud data transmission/reception methods/devices according to embodiments.

The structure of FIG. 10 represents a configuration in which at least one of a server 1060, a robot 1010, a self-driving vehicle 1020, an XR device 1030, a smartphone 1040, a home appliance 1050, and/or a head-mount display (HMD) 1070 is connected to the cloud network 1000. The robot 1010, the self-driving vehicle 1020, the XR device 1030, the smartphone 1040, or the home appliance 1050 is called a device. Further, the XR device 1030 may correspond to a point cloud data (PCC) device according to embodiments or may be operatively connected to the PCC device.

The cloud network 1000 may represent a network that constitutes part of the cloud computing infrastructure or is present in the cloud computing infrastructure. Here, the cloud network 1000 may be configured using a 3G network, 4G or Long Term Evolution (LTE) network, or a 5G network.

The server 1060 may be connected to at least one of the robot 1010, the self-driving vehicle 1020, the XR device 1030, the smartphone 1040, the home appliance 1050, and/or the HMD 1070 over the cloud network 1000 and may assist in at least a part of the processing of the connected devices 1010 to 1070.

The HMD 1070 represents one of the implementation types of the XR device and/or the PCC device according to the embodiments. The HMD type device according to the embodiments includes a communication unit, a control unit, a memory, an I/O unit, a sensor unit, and a power supply unit.

Hereinafter, various embodiments of the devices 1010 to 1050 to which the above-described technology is applied will be described. The devices 1010 to 1050 illustrated in FIG. 10 may be operatively connected/coupled to a point cloud data transmission device and reception device according to the above-described embodiments.

### <PCC+XR>

The XR/PCC device 1030 may employ PCC technology and/or XR (AR+VR) technology, and may be implemented as an HMD, a head-up display (HUD) provided in a vehicle, a television, a mobile phone, a smartphone, a computer, a wearable device, a home appliance, a digital signage, a vehicle, a stationary robot, or a mobile robot.

The XR/PCC device 1030 may analyze 3D point cloud data or image data acquired through various sensors or from an external device and generate position data and attribute data about 3D points. Thereby, the XR/PCC device 1030 may acquire information about the surrounding space or a real object, and render and output an XR object. For example, the XR/PCC device 1030 may match an XR object including auxiliary information about a recognized object with the recognized object and output the matched XR object.

### <PCC+XR+Mobile Phone>

The XR/PCC device 1030 may be implemented as a mobile phone 1040 by applying PCC technology.

The mobile phone 1040 may decode and display point cloud content based on the PCC technology.

### <PCC+Self-Driving+XR>

The self-driving vehicle 1020 may be implemented as a mobile robot, a vehicle, an unmanned aerial vehicle, or the like by applying the PCC technology and the XR technology.

The self-driving vehicle 1020 to which the XR/PCC technology is applied may represent a self-driving vehicle provided with means for providing an XR image, or a self-driving vehicle that is a target of control/interaction in the XR image. In particular, the self-driving vehicle 1020 which is a target of control/interaction in the XR image may be distinguished from the XR device 1030 and may be operatively connected thereto.

The self-driving vehicle 1020 having means for providing an XR/PCC image may acquire sensor information from sensors including a camera, and output the generated XR/PCC image based on the acquired sensor information. For example, the self-driving vehicle 1020 may have an HUD and output an XR/PCC image thereto, thereby providing an occupant with an XR/PCC object corresponding to a real object or an object present on the screen.

When the XR/PCC object is output to the HUD, at least a part of the XR/PCC object may be output to overlap the real object to which the occupant's eyes are directed. On the other hand, when the XR/PCC object is output on a display provided inside the self-driving vehicle, at least a part of the XR/PCC object may be output to overlap an object on the screen. For example, the self-driving vehicle 1020 may output XR/PCC objects corresponding to objects such as a road, another vehicle, a traffic light, a traffic sign, a two-wheeled vehicle, a pedestrian, and a building.

The virtual reality (VR) technology, the augmented reality (AR) technology, the mixed reality (MR) technology and/or the point cloud compression (PCC) technology according to the embodiments are applicable to various devices.

In other words, the VR technology is a display technology that provides only CG images of real-world objects, backgrounds, and the like. On the other hand, the AR technology refers to a technology that shows a virtually created CG image on the image of a real object. The MR technology is similar to the AR technology described above in that virtual objects to be shown are mixed and combined with the real world. However, the MR technology differs from the AR technology in that the AR technology makes a clear distinction between a real object and a virtual object created as a CG image and uses virtual objects as complementary objects for real objects, whereas the MR technology treats virtual objects as objects having equivalent characteristics as real objects. More specifically, an example of MR technology applications is a hologram service.

Recently, the VR, AR, and MR technologies are sometimes referred to as extended reality (XR) technology rather than being clearly distinguished from each other. Accordingly, embodiments of the present disclosure are applicable to any of the VR, AR, MR, and XR technologies. The encoding/decoding based on PCC, V-PCC, and G-PCC techniques is applicable to such technologies.

The PCC method/device according to the embodiments may be applied to a vehicle that provides a self-driving service.

A vehicle that provides the self-driving service is connected to a PCC device for wired/wireless communication.

When the point cloud data (PCC) transmission/reception device according to the embodiments is connected to a vehicle for wired/wireless communication, the device may receive/process content data related to an AR/VR/PCC service, which may be provided together with the self-driving service, and transmit the same to the vehicle. In the case where the PCC transmission/reception device is mounted on a vehicle, the PCC transmission/reception device may receive/process content data related to the AR/VR/PCC service according to a user input signal input through a user interface device and provide the same to the user. The vehicle or the user interface device according to the embodiments may receive a user input signal. The user input signal according to the embodiments may include a signal indicating the self-driving service.

As described above, a point cloud (or point cloud data) is composed of a set of points, and each point may have geometry information and attribute information. The geometry information is three-dimensional position (XYZ) information, and the attribute information includes color (RGB, YUV, etc.) and reflectance. In other words, the attribute information about each point may include at least one of color, reflectance, opacity, frame index, frame number, material identifier, or normal vector.

In the present disclosure, geometry information is used interchangeably with geometry data and geometry. Also, attribute information is used herein interchangeably with attribute data and attributes.

In the present disclosure, the point cloud content providing system may use one or more cameras (e.g., an infrared camera capable of securing depth information, an RGB camera capable of extracting color information corresponding to the depth information, etc.), a projector (e.g., an infrared pattern projector configured to secure depth information, etc.), LiDAR (Light Detection and Ranging), and the like to generate point cloud content (or point cloud data).

LiDAR refers to equipment configured to measure the distance by measuring the time it takes for the emitted light to reflect off a subject and return. It provides precise three-dimensional information about the real world as point cloud data over a wide area and long distance. Such large-volume point cloud data may be widely used in various fields employing computer vision technology, such as autonomous vehicles, robots, and 3D map production. That is, the LiDAR equipment uses a radar system configured to measure the coordinates of a position of a reflector by emitting a laser pulse and measuring the time it takes for the laser pulse to reflect on a subject (i.e., a reflector) in order to generate point cloud content. According to embodiments, the depth information may be extracted through the LiDAR equipment. The point cloud content generated through the LiDAR equipment may be composed of multiple frames. The multiple frames may be integrated into one piece of content.

The LiDAR may be categorized into non-spinning, solid or fixed LiDARs and rotation or spinning LiDAR.

According to embodiments, the fixed LiDAR is installed in a fixed location to collect distance and 3D information related to a surrounding environment. The fixed LiDAR systems are typically used to monitor structures such as buildings, roads, bridges, and tunnels, or to scan terrain features. Because the fixed LiDAR systems are installed in a fixed location, they may continuously monitor a specific area. In addition, they usually do not make a 360-degree horizontal rotation, but mainly emit and receive beams in a vertical direction. That is, they emit beams in one fixed direction at a time, which may result in slow data acquisition. Therefore, the fixed LiDAR is used for precise distance measurements for, for example, a 3D map, and are typically used in static environments.

According to embodiments, a spinning LiDAR system may have multiple lasers (or laser sensors) at different elevations and may be used to capture point cloud data as the lasers spin along an azimuth (horizontal direction) around the Y-axis. These spinning LiDAR systems are often used in applications such as self-driving vehicles, drones, and robots that require fast and accurate acquisition of 3D information in dynamic environments. In a spinning LiDAR system, the laser sensors scans 360 degrees while spinning to acquire data from the surrounding environment in real time, and ensure a faster data acquisition speed than in the fixed LiDAR. They also work effectively in dynamic environments and are often used on moving vehicles or robots.

The present disclosure relates to an apparatus and method for prediction of point cloud data acquired using a fixed LiDAR system, and more particularly, to a method and apparatus for compression of geometry of a point cloud based on inter-frame characteristics of the fixed LiDAR.

The present disclosure proposes a method for searching for an object on a per-point basis based on geometry information in detecting objects between frames to compress 3D point cloud data.

The present disclosure proposes a method for searching for an object on a per-point basis based on geometry information in detecting objects between frames to compress 3D point cloud data.

According to embodiments, in point cloud data, a dynamic point cloud classified into category 3 is composed of multiple point cloud frames, which may be used for self-driving, or the like. The set of frames is called a sequence. A sequence includes frames with the same attribute values. Therefore, the geometry values from frames have features such as a dynamic object that exhibits motion, or a stationary object that does not exhibit motion between earlier and later frames.

Accordingly, the present disclosure proposes a method for intra-frame and/or inter-frame object search and detection with the goal of inter-frame compression of sequences.

The present disclosure also proposes a method of compensating for refraction of point cloud data that may occur due to the nature of fixed LiDAR, and splitting a road and an object from the refraction-compensated point cloud data.

As such, the fixed LiDAR in the present disclosure has the characteristic of xyz based on an optical coordinate system because the points of the point cloud data are acquired using a lens. In addition, the point values of the actual data are acquired using a 2-axis mirror, unlike spinning LiDAR. Therefore, the present disclosure proposes a method of calculating the directions horizontal and perpendicular to the two axes based on the tilt and angle of the vector reflected in the scanning, and compensating the refraction error from the point cloud data in the calculation. Also, the present disclosure proposes a method of splitting the points of the point cloud data scanned on the two axes into a road and objects.

By performing refraction compensation prior to compressing point cloud data and using the same in intra-frame/inter-frame object search, the present disclosure may improve compression efficiency according to the characteristics of objects.

In the present disclosure, the refraction compensation may be performed on at least one of the z, y, and z axes of each point in the point cloud data acquired through fixed LiDAR.

In the present disclosure, to compress geometry information related to the point cloud data, a compression method such as octree-based geometry compression, predictive tree-based geometry compression, or trisoup-based geometry compression may be used.

In the present disclosure, the object search method and/or the method of splitting a road and objects may be performed prior to the predictive tree-based compression of the geometry information. In this case, they may be performed after converting the xyz coordinates to rpl (range, polar angle, azimuthal angle) coordinates.

In the present disclosure, the object search method and/or the method of splitting a road and objects may be performed prior to octree-based compression of the geometry information.

In the present disclosure, the object search method and/or the method of splitting a road and objects may be performed after compensating for (or correcting) refraction of the point cloud data.

According to embodiments, the xyz coordinates are used to represent a position in 3D space of each point in the point cloud data, and the rpl coordinates represent a relative distance and orientation of the points in the point cloud data. In other words, the rpl coordinates are used to represent data measured by a distance measuring device, such as a laser sensor.

In this case, the points converted into the rpl coordinate system are included in an object as one point, and the individual object (or information related to the individual object) may be signaled from the encoder. The encoder of the transmission device may perform object detection in each frame, and an object in the reference frame may not be present in the object list of the current frame. After detection of the object list, motion estimation and motion compensation may be performed for the objects, and a per-object motion estimation matrix may be signaled from the encoder of the transmission device.

As described above, fixed LiDAR may use laser sensors to generate a 3D map environment. In general, LiDAR uses an active laser to illuminate an object to measure the distance to the object (wall, vehicle, tree, etc.). Accordingly, it is a fast and accurate approach and may be used in a variety of environments and conditions.

In particular, spinning LiDAR uses a motor to physically rotate the sensor to scan the environment. The advantage is that it has a wide horizontal field of view, but the disadvantages include its large size, high cost, and lack of durability.

The fixed LiDAR, on the other hand, does not have a spinning mechanical device, but has a narrower horizontal field of view than the spinning LiDAR. For the fixed LiDAR, a lens, called receiver optics, is mainly used. In other words, the speed of light passing through the lens and the direction in which the light is directed determine the characteristics of the data acquired. In lossless compression, the data characteristics contribute to the compression efficiency.

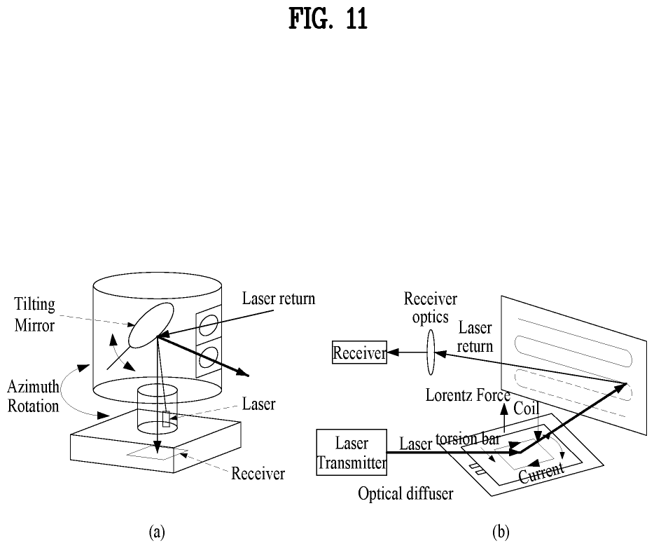

FIG. 11-(a) is a diagram illustrating an example of a spinning LiDAR system according to embodiments.

The spinning LiDAR system according to the embodiments rotates and tilts a laser beam to scan around a subject and collect the returned laser signal to generate 3D data, such as point cloud data.

In FIG. 11-(a), a tilting mirror is used to tilt the laser beam up and down. The tilting mirror may emit the laser beam at different vertical angles to collect multi-dimensional data.

Horizontal (or azimuth) rotation refers to the horizontal rotation of the laser sensor. In other words, the laser sensor horizontally rotates 360 degree to scan around the object.

A laser is used to generate a beam to be emitted from the laser sensor. In particular, lasers are used for precise distance measurement, which is performed when the beam from the laser sensor is reflected and returned. In this operation, the laser sensor is rotated to emit lasers in different directions.

The Laser Return signal indicates the distance to the object. This information is used for subsequent analysis.

The receiver senses the laser return signal and analyzes the signal to calculate distance and environmental information. In particular, the receiver may precisely measure the distance based on the time difference of the laser return signal, and may process multiple reflected signals to generate point cloud data. That is, the receiver may acquire the location coordinates of the object by shooting a laser pulse and measuring the time it takes until the laser pulse is reflected on the object (i.e., the reflector) and returns.

FIG. 11-(b) is a diagram illustrating an example of a fixed LiDAR system according to embodiments.

The fixed LiDAR system in FIG. 11(b) shoots a laser beam and collects the signal reflected and returned from an object to generate point cloud data, such as 3D terrain.

To this end, a laser transmitter generates a laser pulse (i.e., a laser beam), which is emitted from a laser sensor. In generating the laser pulse in the laser transmitter, the Lorentz force may be used.

In a laser transmitter, an electric current and a coil are used to generate the laser pulse. In other words, when the electric current flows through the coil, the Lorentz force is generated, resulting in a laser beam.

The receiver optics include a lens, a mirror, and a light sensor, and collects, focuses, and transmits the received laser return signal to the receiver (i.e., light sensor). This means that the speed of light passing through the lens of the receiver optics and the direction of the light will determine the characteristics of the point cloud data acquired.

Main types of fixed LiDAR include Micro-Electrical-Mechanical System (MEMS), Optical Phase Array (OPA), and Fast LiDAR Scanning Hardware (FLASH).

MEMS may be used to steer the beam direction of a laser sensor. The MEMS technology is used in fixed LiDAR systems to steer the laser beam and scan in different directions.

OPA refers to a technology that allows for software adjustment of beam direction, meaning that with OPA, the laser beam from a laser sensor may be slightly deflected or adjusted to scan in a desired direction. OPA is utilized in fixed LiDAR systems to perform horizontal and vertical scanning of the laser beam.

FLASH supports fast scanning of the laser beam in fixed LiDAR systems. FLASH LiDAR provides extremely fast data acquisition rates, enabling the acquisition of precise 3D terrain information in dynamic environments. This fast scanning hardware may be used to enhance the performance of fixed LiDAR.

The present disclosure proposes a method of predicting geometry information using fixed LiDAR, which is independent of the type of LiDAR, but has different characteristics from spinning LiDAR. In other words, the point cloud data generated using fixed LiDAR is more accurate than the point cloud data generated spinning LiDAR, and is more likely to be used for self-driving than spinning LiDAR. In particular, fixed LiDAR is characterized by high-precision distance measurement.

In other words, fixed LiDAR may be used for object recognition and dense point cloud acquisition with higher compression efficiency due to its accurate object measurement and faster image acquisition speed. In addition, the high precision of the fixed LiDAR enables favorable prediction for motion estimation/compensation, which may increase the efficiency of compression of geometry information.

Therefore, in the present disclosure, when compressing geometry information based on prediction, a predictor may be selected based on a nonlinear relationship between the scanning direction and the scanning principle.

Further, the present disclosure proposes a method for splitting a road and objects and compressing geometry information by utilizing the characteristics of point clouds acquired using fixed LiDAR. That is, fixed LiDAR has the characteristics of xyz based on the optical coordinate system because it acquires points using a lens of the receiver optics. The characteristics of xyz based on the optical coordinate system refer to the coordinates in 3D space of each point acquired through the laser beam (or laser sensor). That is, the x value represents the x coordinate of the point acquired by the LiDAR system, and is measured in the left and right directions centered on the LiDAR system. The x value represents the horizontal position of the point, indicating the relative coordinates of the position of the LiDAR scanning device and the point where the laser beam is reflected. The y value represents the y-coordinate of the point, measured in the front-to-back direction centered on the LiDAR system. The y value represents the vertical position of the point, indicating the relative coordinates of the position of the LiDAR scanning device and the position where the radar beam is reflected. The z value represents the z coordinate of the point, which is the height or elevation of the point where the laser beam is reflected. The z value indicates the relative height of the point from the ground or reference plane.

Also, fixed LiDAR acquires the point values in the actual data using a two-axis mirror, unlike spinning LiDAR. Here, the use of two-axis mirrors in the fixed LiDAR allows the laser sensor to scan in both vertical and horizontal directions to acquire point cloud data.

Therefore, the present disclosure proposes a method for calculating the directions horizontal and perpendicular to the two axes based on the tilt and angle of the vector reflected in the scanning, and compensating for the corresponding refraction error.

Further, the present disclosure proposes a method of splitting the points of the point cloud data scanned on the two axes into a road and objects.

The method proposed herein may be applied in each frame. Further, a method by which each step may be applied to inter-frame compression is proposed.

### Correcting Refraction Error in an Optical Coordinate System

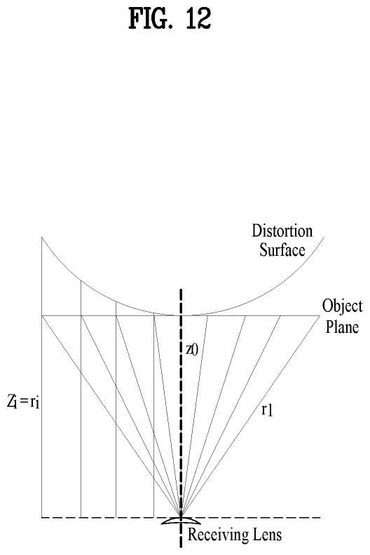

FIG. 12 illustrates an example method of acquiring points using an optical lens according to embodiments.

In FIG. 12, the object plane represents the plane in which the real-world environment or object that the LiDAR system is attempting to measure is located. This plane defines the space in which the laser beam is reflected and travels, and the LiDAR system scans this plane to collect distance data. The target plane may be used to calculate the XYZ coordinates of the LiDAR data.

The distortion surface represents the surface on which the laser beam is refracted or distorted as it passes through an optical lens. In other words, an optical lens is used to adjust and collect the laser beam, and the curvature and shape of the lens changes the path of the light beam. In particular, the complex optical synthesis within the lens causes distortion, which may affect distance and direction measurements.

According to embodiments, in the LiDAR systems of the present disclosure, refraction refers to a change in the direction of a light beam as it passes through an optical lens. That is, a light beam passing through the optical lens is refracted due to a change in travel direction of the light beam. In other words, the laser is emitted through a mirror and received by an optical sensor, which may cause refraction. As such, refraction occurs as the speed of light changes as light rays enter a different medium (material) from the lens. Therefore, the refractive index and curvature of the lens, as well as the shape and thickness of the lens, determine the refraction of the laser beam and are critical to acquiring accurate distance and direction data.

In other words, in LiDAR systems, optical lenses are designed to minimize distortion effects and perform accurate distance and direction measurements. However, not all lenses are perfect, and this may lead to optical distortion (or refraction).

In addition, a receiving lens is used in a LiDAR system to collect the light of the laser beam that reflects back from the object plane. The receiving lens may collect, focus, and direct the light of the laser beam to a light sensor or detector.

As shown in FIG. 12, point cloud data acquired using fixed LiDAR is represented in the xyz coordinate system as in the case of spinning LiDAR. For the spinning LiDAR, when data is converted into a spherical coordinate system (i.e., radius, phi, laserID (or elevation)) and compressed, the acquired data is positioned according to the rpl coordinate system, resulting in higher compression efficiency. The coordinates acquired using fixed LiDAR are similar to a coordinate system perpendicular or horizontal to two axes. Further, even when a specific object is acquired at the same position and the same angle, it has different geometric features depending on the camera used.

Therefore, the present disclosure proposes an optical coordinate system, a coordinate system that is different from conventional coordinate systems, to remove or replace common geometric features in a normalized 3D space with these factors removed.

According to embodiments, the LiDAR system of the present disclosure may include a MEMS mirror and a MEMS detector.

According to embodiments, the MEMS mirror is a mirror including a small, microscopic mechanical system. The mirror is used to direct or scan a laser beam. In particular, the MEMS mirror may be used to quickly scan or redirect a laser beam to collect point cloud data.

According to embodiments, MEMS technology may be used to implement a photosensor or MEMS detector in a LiDAR system.

According to embodiments, the MEMS detector, which is responsible for reception and signal processing in the LiDAR system, measures and interprets the signal of the laser beam that reflects from to a subject (i.e., object) and returns. The MEMS detector adjusts the reception sensitivity of the radar beam, amplifies the signal, and samples the signal over time to calculate distance information.

According to embodiments, the coordinates (x, y) scanned by the MEMS mirror in the present disclosure are converted to normalized coordinates. Therefore, there is a scale factor between the normalized coordinates and the actual coordinates. This is referred to herein as precision.

For example, when the LiDAR system has internal parameters and camera 3D information, the points acquired by a 2D depth camera are positioned in a grid shape according to the precision in 2D, and the depth is positioned at the distance of the acquired laser. In this case, the plane and laser distance may or may not have the same precision.

In the present disclosure, when the deflection angles of the MEMS detector (or MEMS mirror) that scanned the laser beam along the x-axis and y-axis are θₓ (i.e., theta_x) and θ_{y} (i.e., theta_y), respectively, Xᵢ, and Yᵢ in the actual coordinates (Xᵢ, Yᵢ, Zᵢ) in the LiDAR system for a point i in normalized coordinates with target distance information rᵢ and MEMS deflection angles θₓ and θ_{y} may be represented by Equation 1 below.

Xᵢ=rᵢ·sin(θx)·cos(0y)

Yᵢ=rᵢ·cos(θx)·sin(θy) [Equation 1]

In the present disclosure, the z-coordinate (Zᵢ) may be calculated by Equation 2 below based on the X-coordinate (Xᵢ) and Y-coordinate (Yᵢ) in Equation 1. In other words, the 2D coordinates (x, y) by the MEMS scanner are combined with the z-coordinate converted in the time measurement.

$${Z}_{i} = {r}_{i} \cdot \{ 1 - \frac{1}{2} ( {X}_{i}^{2} \cdot {tan}^{2} ( θ x ) + {Y}_{i}^{2} {tan}^{2} ( θ y ) ) \} \qquad [ Equation 2 ]$$

According to embodiments, applying the value of the Z coordinate (Zᵢ) calculated in Equation 2 to the point cloud data acquired using the LiDAR system may compensate for (or correct) refraction occurring in the point cloud data.

In the present disclosure, the Z coordinate (Zᵢ) may represent the height or elevation of each point in the point cloud data. This value indicates the distance from the ground surface and may be used to split a road and an object from the point cloud data.

In the present disclosure, refraction compensation may always be performed or may be performed selectively. To this end, information (e.g., optical_distortion_flag) indicating whether to compensate for refraction may be included in the signaling information and transmitted to the receiving side. If it indicates refraction compensation, the signaling information may further include θₓ (i.e., theta_x) and θ_{y} (i.e., theta_y) to obtain the Z coordinate. That is, theta_x represents the x-axis coefficient in the refraction compensation equations (i.e., see Equations 1 and 2) and theta_y represents the y-axis coefficient in the refraction compensation equations (i.e., see Equations 1 and 2).

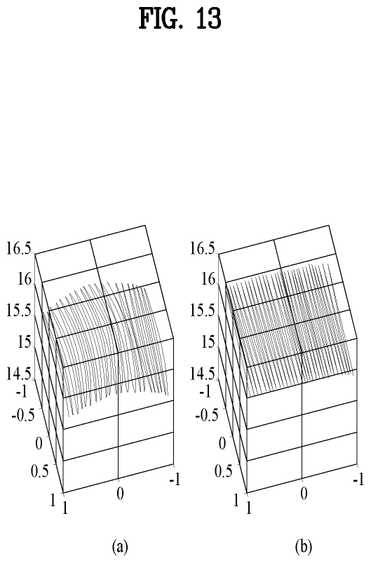

FIGS. 13-(a) and 13-(b) illustrate an example before refraction compensation and an example after refraction compensation according to embodiments. Specifically, FIG. 13-(a) illustrates the degree of refraction prior to the application of refraction compensation. FIG. 13-(b) illustrates the degree of refraction after applying refraction compensation. That is, when a Zᵢ calculation equation such as Equation 2 is applied to the point cloud data with refraction as shown in FIG. 13-(a), refraction-compensated point cloud data may be acquired, as shown in FIG. 13-(b).

In the present disclosure, the angle to the centerline of the plane based on the horizontal axis may be viewed as the refractive index according to the degree of distortion of the point, and the calculated point cloud may be compensated for and compressed by the encoder and may then be transmitted.

The present disclosure may be used to compress refraction-compensated point cloud data, or to perform object search and/or splitting of a road and an object.

### Object Search Methods

In the present disclosure, object search is performed to split roads and objects from point cloud data.

In other words, point cloud content captured by a fixed or spinning LiDAR system on a moving vehicle may contain roads and objects. In other words, a street may contain not only roads, but also many objects, such as trees, buildings, cars, and people. In the present disclosure, point cloud content may be referred to as point cloud data or a point cloud. There may be one or more objects. A plurality of objects may be referred to simply as objects or as an object group or an object block.

When a point cloud is constructed by capturing consecutive frames, the characteristics of motion presented in the consecutive frames of points constituting a road may differ from the characteristics of motion presented in the consecutive frames of points constituting an object (or objects)

Therefore, when compressing geometry information based on inter-prediction, applying the motion represented by the road points between consecutive frames to the objects, or applying the motion represented by the object points to the road may reduce the compression efficiency or result in inaccurate motion prediction.

Therefore, it is necessary to accurately split roads and objects from the point cloud data.

However, when the point cloud data has refraction, splitting a road and an object without compensating for the refraction may lead to misidentifying roads as objects or objects as roads due to the characteristics of refraction.

In one embodiment, to address this issue, roads and objects may be split from the refraction-compensated point cloud data.

According to the present disclosure, geometry information (also referred to as geometry or geometry data) related to the split road and object may be compressed by applying a predictive tree or octree. In other words, in the present disclosure, octree-based geometry compression, predictive tree-based geometry compression, or trisoup-based geometry compression may be used as a method to compress the geometry information.

As such, the present disclosure employs refraction compensation for splitting of a road and an object in order to accurately split roads and objects from point cloud data acquired using fixed LiDAR on sloping or curved roads.

Further, in the case of a fixed LiDAR system, roads and objects cannot be accurately split because the point cloud data is input to the optical receiver or receiving lens, which has distortion in the object plane.

Therefore, the present disclosure proposes an adaptive road/object splitting criterion for the case of large distortion in the xy-plane for acquisition of a wide field of view (FoV) on the optical lens of fixed LiDAR, and for the case of large distortion in the xy-plane due to real-time processing in spinning LiDAR.

In particular, according to the present disclosure, object search may be performed to split roads and objects from a refraction-compensated. In this case, the intra-frame object search may be determined from the refraction compensation applied equation such as Equation 3 below.

In the present disclosure, when the 2D deflection angles of the scanned MEMS detector are θₓ and θ_{y} in Equation 3 below, points within the threshold α<θₓ<α′ and β<θ_{y}<β′ may be split into roads and objects. In the present disclosure, α, α′, β, and β′ are thresholds used to split roads and objects.

$${Z}_{i} = {r}_{i} \cdot \{ 1 - \frac{1}{2} ( {X}_{i}^{2} \cdot {tan}^{2} ( θ x ) + {Y}_{i}^{2} \cdot {tan}^{2} ( θ y ) ) \} \qquad [ Equation 3 ]$$

In the present disclosure, each point in the point cloud data may be split into a road or an object based on the value of Zᵢ calculated in Equation 3.

In the present disclosure, the value of Xᵢ and value of Yᵢ of each point in the point cloud data may be obtained by applying θₓ and θ_{y} to Equation 1 as described above. The value of Xᵢ and value of Yᵢ obtained in this way may be applied to Equation 3 to obtain the value of Zᵢ.

Here, the value of Xᵢ (or Xᵢ coordinate) indicates the left and right direction of the point, the value of Yᵢ (or Yᵢ coordinate) indicates the front and back direction of the point, and the value of Zᵢ (or Zᵢ coordinate) indicates the height or elevation of the point. In other words, the value of Zᵢ may mean the height of the point from the ground surface or a reference plane (e.g., the relative height from the ground surface). Typically, the value of Xᵢ may be measured from left (−x) to right (+x) based on the LiDAR system, the value of Yᵢ may be measured from back (−y) to front (+y) based on the LiDAR system, and the value of Zᵢ may be measured in a positive (+) direction above the ground surface. This is an embodiment provided to provide understanding of the present disclosure, and the method of measuring the value of Xᵢ, value of Yᵢ, and value of Zᵢ may vary. For example, the value of Xᵢ may be measured from right to left around the LiDAR system, the value of Yᵢ may be measured from top to bottom around the LiDAR system, and the value of Zᵢ may be measured from front to back of the ground surface. In other words, the definitions of the values of Xᵢ, Yᵢ, and Zᵢ may depend on the measurement method.

In the present disclosure, the value of Zᵢ may be used to split a road and an object from point cloud data. For example, if the value of Zᵢ of point i is less than a threshold, point i may be classified as a road. Otherwise, it may be classified as an object. For example, when the position of the point captured by the laser sensor is lower than or equal to the value of Zᵢ, point i may be classified as a road. When it is higher than the value, point i may be classified as an object.

In the present disclosure, the value of Zᵢ may be used to split a road and an object from point cloud data. For example, if the value of Zᵢ of point i is less than a threshold, point i may be classified as a road. Otherwise, it may be classified as an object. For example, when the position of the point captured by the laser sensor is lower than or equal to the value of Zᵢ, point i may be classified as a road. When it is higher than the value, point i may be classified as an object.

In a frame composed of point cloud data, the left and right sides may be different from each other due to distortion (or refractive index). For example, the left side may be more squashed or the right side may be more stretched.

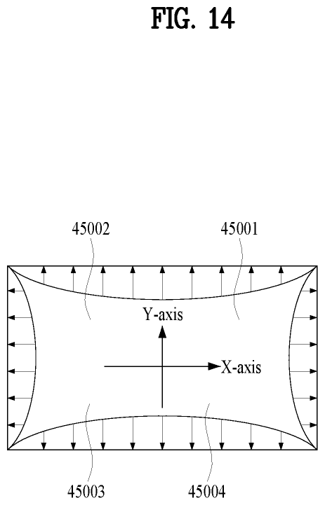

FIG. 14 is a diagram showing an example xy-plane with refraction compensation applied according to embodiments. In FIG. 14, the portions indicated by dashed lines are an example of refraction that may occur due to characteristics of a road.

That is, the xy plane may be divided into four parts by the coordinate axes (x-axis, y-axis), which may be, in counterclockwise order, the first quadrant 45001, the second quadrant 45002, the third quadrant 45003, and the fourth quadrant 45004. Each point may be in one of the first quadrant 45001 to the fourth quadrant 45004. For example, the points in the first quadrant 45001 have positive x-coordinates and positive y-coordinates. The points in the second quadrant 45002 have negative x-coordinates and positive y-coordinates. The points in the third quadrant 45003 have negative x coordinates and negative y coordinates. The points in the fourth quadrant 45004 have positive x coordinates and negative y coordinates.

The thresholds α, α′, β, and β′ may be modified on the assumption that when the value of Zᵢ varies with the left/right refractive index, the refractive index increases in the direction in which the value increase/decreases from the center of the screen on the x-axis.

According to embodiments, the amount of change on the x-axis is from xₘᵢₙ to xₘₐₓ and the amount of change on the y-axis is from yₘᵢₙ to yₘₐₓ. For point position values calculated as the coordinates (Xᵢ, Yᵢ, Zᵢ) by the LiDAR system, the minimum value of X is defined as xₘᵢₙ and the maximum value of X is defined as xₘₐₓ. Also, the minimum value of Y is defined as yₘᵢₙ and the maximum value of Y is defined as yₘₐₓ. In other words, xₘᵢₙ, xₘₐₓ, yₘᵢₙ, and yₘₐₓ may be referred to as thresholds that may determine the refraction compensation range.

According to embodiments, xₘᵢₙ, xₘₐₓ, yₘᵢₙ, and y max may be set through the LiDAR system by obtaining the actual coordinates X and Y based the deflection angles θₓ and θ_{y} for the coordinates (x, y) scanned by the MEMS mirror, obtaining a minimum value xₘᵢₙ and a maximum value xₘₐₓ among the values of X, and obtaining a minimum value yₘᵢₙ and a maximum value yₘₐₓ among the values of Y.

In the present disclosure, in order to compensate for the adaptive refraction degree for point cloud data, the condition for the compensation coordinates of the point (x, y) may be defined as Equation 4 below.

First quadrant: For X>0 and Y>0, (x+x/(yₘₐₓ−yₘᵢₙ),y)

Second quadrant: For X<0 and Y>0, (x,y+y/(xₘₐₓ−xₘᵢₙ))

Third quadrant: For X<0 and Y<0, (x,y/(xₘₐₓ−xₘᵢₙ))

Fourth quadrant: For X>0 and Y<0, (x/(yₘₐₓ−yₘᵢₙ),y) [Equation 4]

For example, assuming that point i is in the first quadrant, Xᵢ is corrected to (x+x/(yₘₐₓ-yₘᵢₙ), and Yᵢ becomes y as it is to compensate for refraction. That is, Xₘₐₓ−Xₘᵢₙ may mean the amount of change in the x−axis, yₘₐₓ-yₘᵢₙ may mean the amount of change in the y-axis, each of which may indicate a threshold for refraction compensation. In this way, for a specific point in the point cloud data, the refraction may be compensated for not only along the z-axis but also along the x-axis and y-axis.

FIG. 14 is a graphical representation of the coordinates of the point cloud data after applying the refraction compensation value of Equation 4 according to the present disclosure.

According to embodiments, the compensated points may be classified as a road or an object using a histogram classification method. Alternatively, other object/road splitting methods may be used. The present disclosure may limit the predictor selection using inter-frame compression on the split road, and/or may limit the predictor selection between objects.

Further, a refraction compensation value (e.g., theta_x, theta_y) for road/object splitting may be signaled by the encoder at the transmission device, and the decoder of the reception device may reconstruct the point cloud data by applying the refraction compensation value. As such, according to the present disclosure, refraction may be compensated for based on the value of Z and/or may be compensated for based on the values of X and Y in the xy plane before splitting the points in the point cloud data into a road and an object. Further, in the present disclosure, the value of Z may be used to split points in the point cloud data into a road and an object.

According to embodiments, the splitting of a road and an object from the point cloud content (i.e., point cloud data) may be performed by the encoder at the transmitting side or by the decoder at the receiving side. For example, in the case where the splitting of a road and an object from the point cloud data is performed by the encoder at the transmitting side, this splitting operation may be skipped at the receiving side. Conversely, in the case the splitting of a road and an object from the point cloud data is performed by the decoder at the receiving side, this splitting operation may be skipped at the transmitting side. According to embodiments, whether the splitting of a road and an object from the point cloud data is to be performed by the encoder at the transmitting side or by the decoder at the receiving side may be indicated using signaling information, or may be determined based on signaling information.

In one embodiment, the splitting of the road and the object is performed by the encoder at the transmitting side.

According to embodiments, once the road and object are split from the point cloud data, a prediction unit may be configured with the points split as the road and a prediction unit may be configured with the points split as the object (or object group). Then, inter-prediction or intra-prediction may be performed for each of the prediction units. That is, motion estimation/compensation may or may not be performed on each of the prediction units. For example, motion estimation/compensation may not be performed on the prediction unit composed of the points split as the road, but may be performed on the prediction unit composed of the points split as the object, or vice versa.

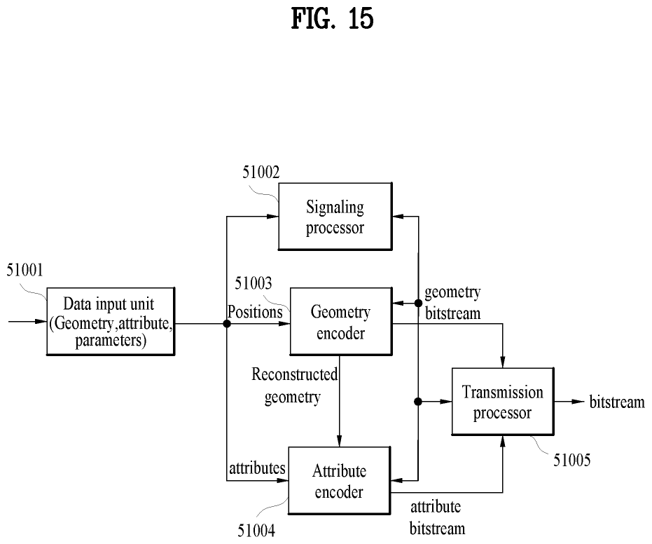

FIG. 15 is a diagram illustrating another example of a point cloud transmission device according to embodiments. The elements of the point cloud transmission device illustrated in FIG. 15 may be implemented by hardware, software, a processor, and/or a combination thereof.

According to embodiments, the point cloud transmission device may include a data input unit 51001, a signaling processor 51002, a geometry encoder 51003, an attribute encoder 51004, and a transmission processor 51005.

The geometry encoder 51003 and attribute encoder 51004 may perform some or all of the operations described in relation to the point cloud video encoder 10002 of FIG. 1, the encoding 20001 of FIG. 2, the point cloud video encoder of FIG. 3, or the point cloud video encoder of FIG. 8.

The data input unit 51001 receives or acquires point cloud data. The data input unit 51001 may perform some or all of the operations of the point cloud video acquisition unit 10001 of FIG. 1, or may perform some or all of the operations of the data input unit 8000 of FIG. 8.

The data input unit 51001 outputs the positions of the points in the point cloud data to the geometry encoder 51003 and outputs the attributes of the points in the point cloud data to the attribute encoder 51004. Here, the input point cloud data may be frame-by-frame, tile-by-tile, or slice-by-slice data. In one embodiment, the point cloud data may be refraction-compensated, split into a road and an object, and input to the data input unit 51001. In the present disclosure, the points in the point cloud data may be refraction-compensated based on the value of Z and/or based on the values of X and Y in the xy plane. Further, in the present disclosure, the value of Z may be used to split the points in the point cloud data into a road and an object. In the present disclosure, refraction compensation and splitting of a road and an object have been described in detail with reference to FIGS. 11 to 14, and will not be described herein to avoid redundancy.

Parameters are output to the signaling processor 51002. According to embodiments, the parameters may be provided to the geometry encoder 51003 and the attribute encoder 51004.

The geometry encoder 51003 compresses the geometry information by performing inter- or intra-prediction-based encoding in a tree structure (e.g., a predictive tree or an octree) on the positions of the points (i.e., geometry information) that are input in the unit of at least one of the following units: frame/tile/slice/Large Prediction Unit (LPU)/PU/road/object/objects. Further, the geometry encoder 51003 performs entropy encoding on the compressed geometry information and outputs the encoded information to the transmission processor 51005 in the form of a geometry bitstream.

The geometry encoder 51003 reconstructs the geometry information based on the positions changed by the compression, and outputs the reconstructed (or decoded) geometry information to the attribute encoder 51004.

The attribute encoder 51004 compresses the input attribute information based on the positions for which no geometry encoding was performed and/or the reconstructed geometry information. In one embodiment, the attribute information may be coded using any one or a combination of one or more of RAHT coding, LOD-based predictive transform coding, and lifting transform coding. The attribute encoder 51004 performs entropy encoding on the compressed attribute information and outputs the encoded information to the transmission processor 51005 in the form of an attribute bitstream.

The signaling processor 51002 may generate and/or process signaling information (e.g., parameters) necessary for encoding/decoding/rendering of the geometry information and attribute information, and provide the same to the geometry encoder 51003, the attribute encoder 51004, and/or the transmission processor 51005. Alternatively, the signaling processor 51002 may be provided with signaling information generated by the geometry encoder 51003, the attribute encoder 51004, and/or the transmission processor 51005. The signaling processor 51002 may provide information (e.g., head orientation information and/or viewport information) fed back from the reception device to the geometry encoder 51003, the attribute encoder 51004, and/or the transmission processor 51005.

As used herein, the signaling information may be signaled and transmitted in a parameter set (SPS (sequence parameter set), GPS (geometry parameter set), APS (attribute parameter set), TPS (tile parameter set) (also referred to as tile inventory), etc). It may also be signaled and transmitted in coding units (or compression units or prediction units) of each video, such as slices or tiles. Here, the SPS includes sequence-level signaling information, the GPS includes information for encoding/decoding of geometry information, the APS includes information for encoding/decoding of attribute information, and the TPS includes information related to tiles.

A method/device according to the embodiments may signal related information to add/perform an operation of the embodiments. The signaling information according to the embodiments may be used by a transmission device and/or a reception device.

The transmission processor 51005 according to the embodiments may perform an operation and/or transmission method identical or similar to the operation and/or transmission method of the transmission processor 8012 of FIG. 8, and perform an operation and/or transmission method identical or similar to the operation and/or transmission method of the transmitter 10003 of FIG. 1. For details, refer to the description of FIG. 1 or 8.

The transmission processor 51005 may multiplex the geometry bitstream output from the geometry encoder 51003, the attribute bitstream output from the attribute encoder 51004, and the signaling bitstream output from the signaling processor 51002 into a single bitstream and transmit the single bitstream, or may encapsulate bitstream into a file, segment, or the like to be transmitted. In one embodiment, the file is in the ISOBMFF file format.

According to embodiments, the file or segment may be transmitted to the reception device, or may be stored in a digital storage medium (e.g., USB, SD, CD, DVD, Blu-ray, HDD, SSD, etc.). The transmission processor 51005 according to the embodiments is capable of wired/wireless communication with the reception device over a network of 4G, 5G, 6G, etc. In addition, the transmission processor 51005 may perform a necessary data processing operation according to the network system (e.g., a 4G, 5G or 6G communication network system). The transmission processor 51005 may transmit the encapsulated data in an on-demand manner.

According to embodiments, the aforementioned refraction compensation-related information may be embedded in the SPS, GPS, APS, and/or TPS and/or geometry data unit (also referred to as geometry slice bitstream) and/or attribute data unit (also referred to as attribute slice bitstream) and transmitted by at least one of the signaling processor 51002, geometry encoder 51003, attribute encoder 51004, or transmission processor 51005.

According to embodiments, the refraction compensation-related information may include information indicating whether refraction compensation is performed (optical_distortion_flag) and information for obtaining the value of Z (e.g., theta_x, theta_y), where theta_x denotes the x-axis coefficient in the refraction compensation equations (e.g., see Equations 1 and 2) and theta_y denotes the y-axis coefficient in the refraction compensation equations (e.g., see Equations 1 and 2). In the present disclosure, the refraction compensation-related information may be referred to as object detection structure information using refraction compensation.

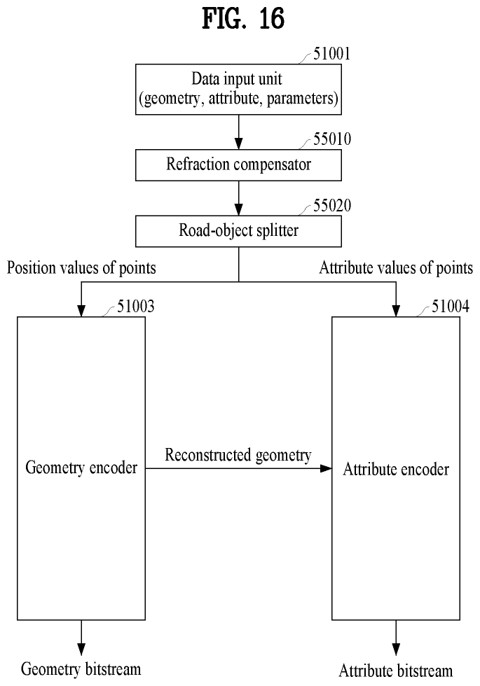

FIG. 16 is a block diagram illustrating an example point cloud video encoder in a transmission device according to embodiments. FIG. 16 is an example of the transmission device of FIG. 15 further including a refraction compensator 55010 and a road-object splitter 55020. According to embodiments, the refraction compensator 55010 and the road-object splitter 55020 may be included in the geometry encoder 51003, or may be configured separately from the geometry encoder 51003, as shown in FIG. 16.

In FIG. 16, the refraction compensator 55010 compensates for refraction occurring in the point cloud data acquired by the LiDAR system (e.g., a fixed LiDAR system) in relation to reference to FIGS. 11 to 14 and Equations 1 to 4. According to embodiments, points in the point cloud data may be refraction-compensated based on the value of Z and/or based on the values of X and Y in the xy plane.

In FIG. 16, the road-object splitter 55020 may categorize the points in the refraction compensated point cloud data into a road and an object. According to embodiments, the road-object splitter 55020 may split the points in the point cloud data into a road or an object based on the value of Z. The value of Z may be obtained by applying Equation 2 or Equation 3. According to embodiments, the road-object splitter 55020 may perform road/object splitting using refraction compensation and signal a histogram classification based on the value of z.

In the case where the road-object splitter 55020 has split the point cloud data into a road and an object, and processed and transmitted the point cloud data for each of the split road and object, the operation of splitting into a road and an object may be skipped by the reception device. However, in the case where the process of splitting the point cloud data into a road and an object is not performed in the road-object splitter 55020, or when the point cloud data is split into a road and an object, processed, and transmitted without distinguishing between the road and the object, the process of splitting the point cloud data into a road and an object may be additionally performed by the reception device.

According to embodiments, the road/object to splitter 55020 may configure a prediction unit from the points split into the road and a prediction unit from the points split into the object (or object group).

The geometry encoder 51003 identifies (or determines) whether to encode, on an octree basis, a predictive tree basis, or a trisoup basis, the geometry information related to the point cloud data split into the road and the object by the road-object splitter 55020. For example, it may be determined based on geometry coding type information (geom_tree_type) in the GPS.

When the octree-based geometry compression is identified, an octree is generated based on the positions of the points (i.e., geometry information) input in at least one of the following units: frame, tile, slice, Large Prediction Unit (LPU), prediction unit (PU), road, object, or object group, and the geometry information is compressed based on the octree. When the trisoup-based geometry compression is identified, a trisoup is generated based on the positions of the points (i.e., geometry information) input in at least one of the following units: frame/tile/slice/LPU/PU/road/object/object group, and the geometry information is compressed based on the trisoup.

When the predictive tree-based geometry compression is identified, a predictive tree is generated based on the positions of the points (i.e., geometry information) input in at least one of the following units: frame/tile/slice/LPU/PU/road/object/object group, and the geometry information is compressed by performing inter-prediction or intra-prediction-based encoding in the predictive tree.

Further, the geometry encoder 51003 performs entropy encoding on the compressed geometry information and outputs the encoded information in the form of a geometry bitstream. The geometry encoder 51003 may perform inter- or intra-prediction on a per-prediction unit basis. In other words, it may or may not perform motion estimation/compensation on a per-prediction unit basis. For example, motion estimation/compensation may not be performed on the prediction unit composed of the points split as the road, but may be performed on the prediction unit composed of the points split as the object, or vice versa.

The geometry encoder 51003 reconstructs the geometry information based on the changed positions through compression, and outputs the reconstructed (or restored) geometry information to said attribute encoder 51004.

The attribute encoder 51004 compresses the input attribute information based on the positions for which no geometry encoding was performed and/or the reconstructed geometry information. In one embodiment, the attribute information may be coded using any one or a combination of one or more of RAHT coding, LOD-based predictive transform coding, and lifting transform coding. The attribute encoder 51004 performs entropy encoding on the compressed attribute information and outputs the encoded information to the transmission processor 51005 in the form of an attribute bitstream.

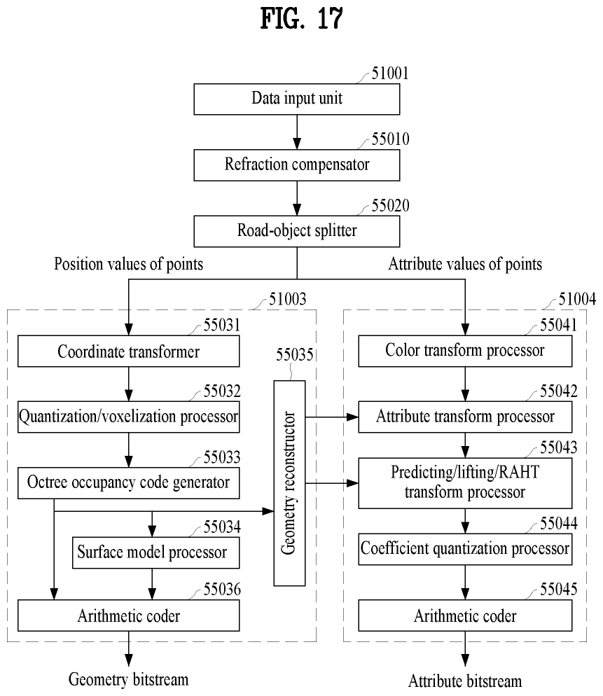

FIG. 17 is a block diagram illustrating an example point cloud video encoder in a transmission device according to embodiments. FIG. 17 is a block diagram illustrating an example of octree-based compression of geometry information related to the point cloud data split into a road and an object after refraction is compensated for. That is, the operations in FIG. 17 may be performed when the geometry coding type information (geom_tree_type) indicates octree-based geometry compression.

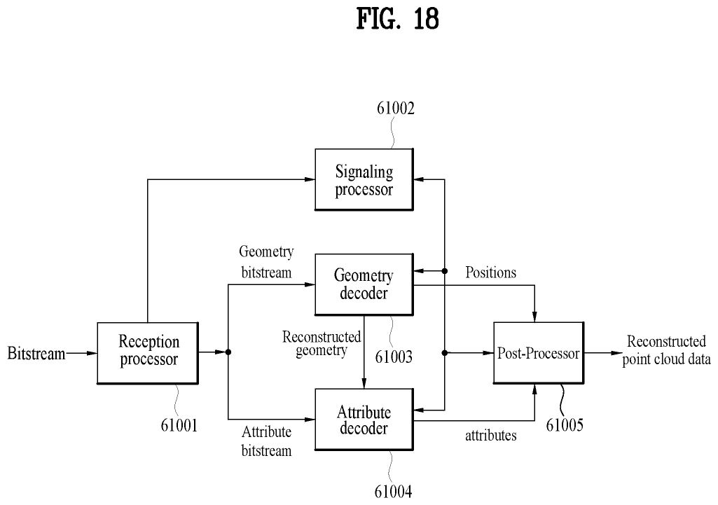

In FIG. 17, for details of refraction compensation and road/object splitting, which are skipped, refer to the descriptions of FIGS. 11 to 16. Further, for details of each block for compressing geometry information and attribute information, refers to the description of FIG. 8. FIG. 18 is a diagram illustrating another example of a point cloud reception device according to embodiments.

The point cloud reception device according to the embodiments may include a reception processor 61001, a signaling processor 61002, a geometry decoder 61003, an attribute decoder 61004, and a post-processor 61005. According to embodiments, the geometry decoder 61003 and the attribute decoder 61004 may be referred to as a point cloud video decoder. According to embodiments, the point cloud video decoder may be referred to as a PCC decoder, a PCC decoding unit, a point cloud decoder, a point cloud decoding unit, or the like.

The reception processor 61001 according to the embodiments may receive a single bitstream, or may receive a geometry bitstream, an attribute bitstream, and a signaling bitstream, respectively. When a file and/or segment is received, the reception processor 61001 according to the embodiments may decapsulate the received file and/or segment and output the decapsulated file and/or segment as a bitstream.

When the single bitstream is received (or decapsulated), the reception processor 61001 according to the embodiments may demultiplex the geometry bitstream, the attribute bitstream, and/or the signaling bitstream from the single bitstream. The reception processor 61001 may output the demultiplexed signaling bitstream to the signaling processor 61002, the geometry bitstream to the geometry decoder 61003, and the attribute bitstream to the attribute decoder 61004.

In this case, the bitstream (or geometry bitstream) may be received split into a road and an object.

When the geometry bitstream, the attribute bitstream, and/or the signaling bitstream are received (or decapsulated), respectively, the reception processor 61001 according to the embodiments may deliver the signaling bitstream to the signaling processor 61002, the geometry bitstream to the geometry decoder 61003, and the attribute bitstream to the attribute decoder 61004.

The signaling processor 61002 may parse signaling information, for example, information contained in the SPS, GPS, APS, TPS, metadata, or the like from the input signaling bitstream, process the parsed information, and provide the processed information to the geometry decoder 61003, the attribute decoder 61004, and the post-processor 61005. In another embodiment, signaling information contained in the geometry slice header and/or the attribute slice header may also be parsed by the signaling processor 61002 prior to decoding the corresponding slice data. The signaling information may include scaling-related information.

For example, when the point cloud data is partitioned into tiles and/or slices at the transmitting side, the TPS includes the number of slices included in each tile, and accordingly the point cloud video decoder according to the embodiments may check the number of slices and quickly parse the information for parallel decoding. Further, the point cloud video decoder according to the present disclosure may quickly parse a bitstream containing point cloud data as it receives an SPS having a reduced amount of data. The reception device may decode tiles upon receiving the tiles, and may perform decoding on a per-slice basis based on the GPS and APS included in each tile. Thereby, decoding efficiency may be maximized.

The geometry decoder 61003 may reconstruct the geometry by performing the reverse process to the operations of the geometry encoder 51006 of FIGS. 15 to 17 on the compressed geometry bitstream based on signaling information (e.g., geometry related parameters).

That is, the geometry decoder 61003 may decode the geometry information (also referred to as geometry or geometry data) by applying a predictive tree, octree, or trisoup based on the geometry coding type information (geom_tree_type) in the GPS. In other words, octree-based geometry decoding, predictive tree-based geometry decoding, or trisoup-based geometry decoding may be used to decode the geometry information.

When it is assumed that the points are split into a road and an object at the transmitting side, the geometry decoder 61003 may perform decoding on the points split as the road and the points split as the object, respectively. For example, motion compensation may not be performed for the prediction unit composed of the points split as the road, and motion compensation may be performed for the prediction unit composed of the points split as the object.

According to embodiments, a refraction compensation inverse transform may be performed on the geometry bitstream, and then the transformed bitstream may be input to the geometry decoder 61003.

The geometry restored (or reconstructed) by the geometry decoder 61003 is provided to the attribute decoder 61004.

The attribute decoder 61004 may restore the attribute by performing the reverse process to the operations of the attribute encoder 51004 of FIG. 15 on the compressed attribute bitstream based on signaling information (e.g., attribute related parameters) and the reconstructed geometry. According to embodiments, when the point cloud data is partitioned into tiles and/or slices at the transmitting side, the geometry decoder 61003 and the attribute decoder 61004 perform geometry decoding and attribute decoding on a tile-by-tile basis and/or slice-by-slice basis.

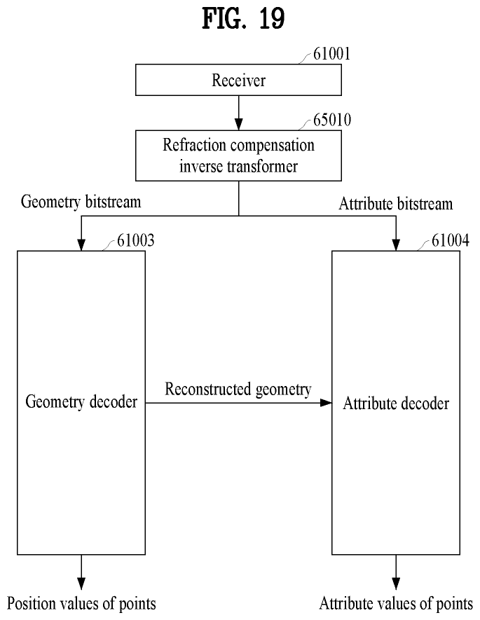

FIG. 19 is a block diagram illustrating an example point cloud video decoder in a reception device according to embodiments. FIG. 19 is an example of the reception device of FIG. 18 with the addition of a refraction compensation inverse transformer 65010.

The refraction compensation inverse transformer 65010 performs a refraction compensation inverse transform based on refraction compensation-related information (e.g., optical_distortion_flag, theta_x, theta_y) included in the signaling information. Here, optical_distortion_flag indicates whether refraction compensation is applied, theta_x denotes the x-axis coefficient in the refraction compensation equations (i.e., see Equations 1 and 2), and theta_y denotes the y-axis coefficient in the refraction compensation equations (i.e., see Equations 1 and 2). Based on theta_x and theta_y, a value of Z may be obtained, which may be used in performing refraction compensation inverse transform on the geometry bitstream.

According to embodiments, the refraction compensation inverse transformer 65010 may perform a refraction compensation inverse transform when the value of optical_distortion_flag is true. In other words, the refraction compensation inverse transform may be performed on the geometry bitstream based on the application status of refraction compensation and the coefficients theta_x, theta_y in the refraction compensation equations.

According to embodiments, the refraction compensation inverse transformer 65010 may perform the refraction compensation inverse transform by applying xₘᵢₙ, xₘₐₓ, yₘᵢₙ, and yₘₐₓ to Equation 4 to reconstruct the point cloud data given before refraction compensation. Here, the amount of change in the x-axis ranges from xₘᵢₙ to xₘₐₓ, and the amount of change in the y-axis ranges from yₘᵢₙ to yₘₐₓ.

According to embodiments, xₘᵢₙ, xₘₐₓ, yₘᵢₙ, and yₘₐₓ may be set through the LiDAR system by obtaining the actual coordinates X and Y based the deflection angles θₓ and θ_{y} for the coordinates (x, y) scanned by the MEMS mirror, obtaining a minimum value xₘᵢₙ and a maximum value xₘₐₓ among the values of X, and obtaining a minimum value yₘᵢₙ and a maximum value yₘₐₓ among the values of Y.

According to other embodiments, xₘᵢₙ, xₘₐₓ, yₘᵢₙ, and yₘₐₓ may be obtained from signaling information, or may be calculated or inferred using other information (e.g., bounding box information and/or slice-related information).

In FIG. 19, for details of the operations of the geometry decoder 61003 and the attribute decoder 61004, which are the same as those in FIG. 18, refer to FIG. 18.

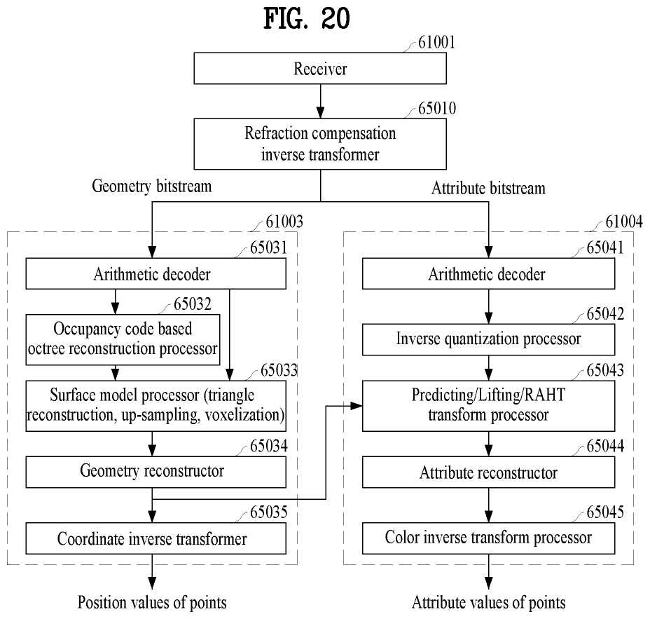

FIG. 20 is a block diagram illustrating an example point cloud video decoder in a reception device according to embodiments. FIG. 20 is a block diagram illustrating example octree-based decoding of a refraction-compensated inverse transformed geometry bitstream.

In FIG. 20, for the refraction compensation inverse transform, which is skipped below, refer to the description of FIG. 19. For details of each block for decoding geometry information and attribute information, refer to the description of FIG. 9.

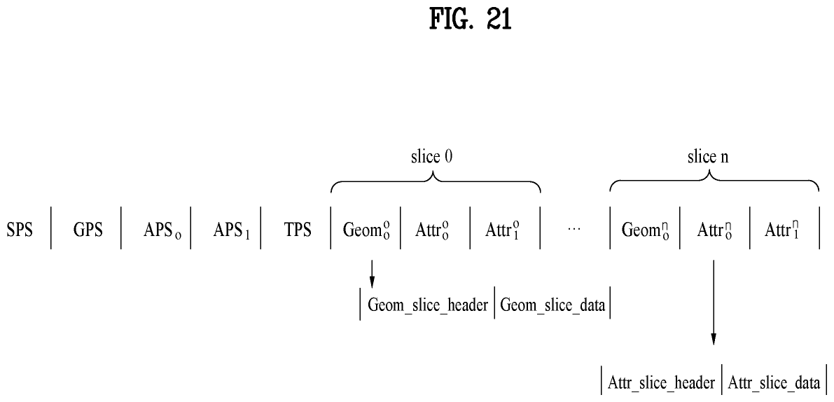

FIG. 21 illustrates an example bitstream structure of point cloud data for transmission/reception according to embodiments.

In order to add/perform the embodiments described so far, related information may be signaled. The signaling information according to the embodiments may be used by a point cloud video encoder at the transmitting side or a point cloud video decoder at the receiving side.

The point cloud video encoder according to the embodiments may generate a bitstream as shown in FIG. 21 by encoding geometry information and attribute information as described above. In addition, signaling information related to the point cloud data may be generated and processed by at least one of the geometry encoder, the attribute encoder, or the signaling processor of the point cloud video encoder, and may be included in the bitstream.

The signaling information according to the embodiments may be received/acquired by at least one of the geometry decoder, the attribute decoder, or the signaling processor of the point cloud video decoder.

A bitstream according to embodiments may be divided into a geometry bitstream, an attribute bitstream, and a signaling bitstream to be transmitted/received, or one combined bitstream may be transmitted/received.

When a geometry bitstream, an attribute bitstream, and a signaling bitstream according to embodiments are configured in one bitstream, the bitstream may include one or more sub-bitstreams. The bitstream according to the embodiments may include a sequence parameter set (SPS) for sequence level signaling, a geometry parameter set (GPS) for signaling of geometry information coding, one or more attribute parameter sets (APSs) (APS₀, APS₁) for signaling of attribute information coding, a tile parameter set (TPS) for tile level signaling, and one or more slices (slice 0 to slice n). That is, a bitstream of point cloud data according to the embodiments may include one or more tiles, wherein each of the tiles may be a group of slices including one or more slices (slice 0 to slice n). The TPS according to the embodiments may contain information about each of the one or more tiles (e.g., coordinate value information and height/size information about the bounding box). Each slice may include one geometry bitstream (Geom0) and one or more attribute bitstreams (Attr0 and Attr1). For example, a first slice (slice 0) may include one geometry bitstream (Geom0⁰) and one or more attribute bitstreams (Attr0⁰, Attr1⁰).

The geometry bitstream within in each slice (also referred to as a geometry slice) may include a geometry slice header (geom_slice_header) and geometry slice data (geom_slice_data). In some embodiments, the geometry bitstream within each slice is referred to as a geometry data unit, the geometry slice header is referred to as a geometry data unit header, and the geometry slice data is referred to as geometry data unit data.

Each attribute bitstream (or attribute slice) within each slice may include an attribute slice header (attr_slice_header) and attribute slice data (attr_slice_data). In some embodiments, the attribute bitstream within each slice may be referred to as an attribute data unit, the attribute slice header may be referred to as an attribute data unit header, and the attribute slice data may be referred to as attribute data unit data.

The transmission device according to the embodiments may transmit the point cloud data according to the bitstream structure as shown in FIG. 21. Thus, different encoding operations may be applied according to the importance level and a good-quality encoding method may be used for an important region. In addition, efficient encoding and transmission according to the characteristics of the point cloud data may be supported and attribute values may be provided according to user requirements.

As the reception device according to the embodiments may receive the point cloud data according to the bitstream structure as shown in FIG. 21. Accordingly, different filtering (decoding method) may be applied to the respective regions (divided into tiles or slices) according to the processing capacity of the reception device, rather than applying a complex decoding (filtering) method to the entire point cloud data. Thereby, a better image quality may be provided for regions important to the user and appropriate latency may be ensured in the system.

As described above, tiles or slices are provided to process the point cloud data by partitioning the point cloud data into regions. In partitioning the point cloud data into regions, an option to generate a different set of neighbor points for each region may be configured. Thereby, a selection method having low complexity and slightly lower reliability, or a selection method having high complexity and high reliability may be provided.

According to embodiments, at least one of the SPS, GPS, TPS, APS, geometry slice header, or attribute slice header may include information related to refraction compensation.

That is, a signal (e.g., information related to refraction compensation) may have different meanings depending on where it is delivered. When it is defined in the SPS, it may apply equally to the entire sequence. When the signal is defined in the GPS, it may indicate that the signaling is used for position reconstruction. When the signal is defined in the APS, it may indicate that the signaling applies to attribute reconstruction. When the signal is defined in the TPS, it may indicate that the signaling applies only to the points within a tile. When the signal is delivered at the slice level, it may indicate that the signaling applies only to the corresponding slice. In addition, where the fields (or syntax elements) defined below are applicable to multiple point cloud data streams in addition to the current point cloud data stream, they may be delivered in a higher-level parameter set or the like.

The term field, as used in the syntax of the present disclosure described hereinafter, may have the same meaning as a parameter or element.

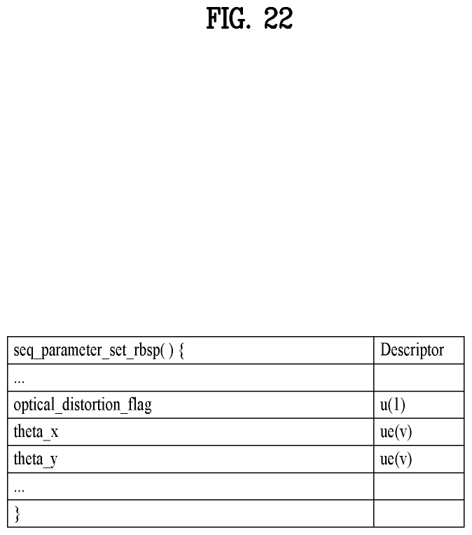

FIG. 22 shows a syntax structure of a sequence parameter set (seq_parameter_set_rbsp( )) (SPS) according to an embodiment of the present disclosure. The SPS may include sequence information about a bitstream of point cloud data. In particular, in the illustrated example. The SPS includes information related to refraction compensation.

In FIG. 22, the SPS may include an optical_distortion_flag field.

The optical_distortion_flag field may indicate whether refraction compensation is performed on the point cloud data in the sequence (or frame). optical_distortion_flag set to 1 may indicate that refraction compensation is performed, and optical_distortion_flag set to 0 may indicate that refraction compensation is not performed. In other words, the optical_distortion_flag field may signal whether refraction compensation is to be used for splitting of a road/object from the point cloud data in the sequence (or frame).

When the value of the optical_distortion_flag field is true, indicating refraction compensation, the SPS may further include a theta_x field and a theta_y field.

theta_x indicates the x-axis coefficient in the refraction compensation equations (i.e., see Equation 1 to Equation 3), and theta_y indicates the y-axis coefficient in the refraction compensation equation (i.e., see Equation 1 to Equation 3). In other words, the transmission device may signal in the SPS the x-axis coefficient (theta_x) and the y-axis coefficient (theta_y) for the refraction compensation equations.

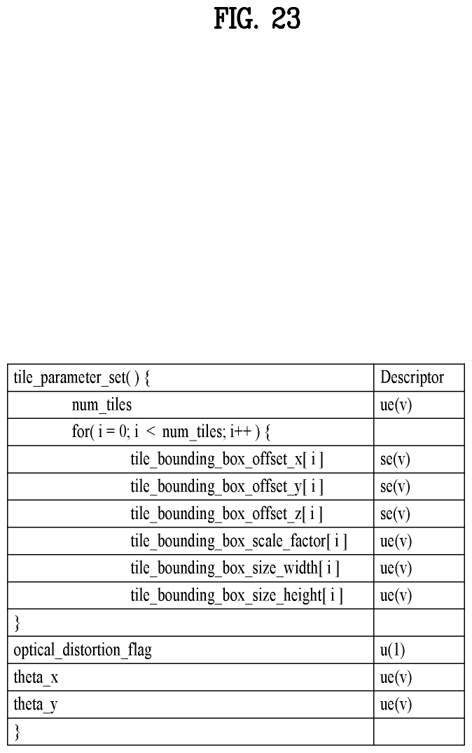

FIG. 23 shows a syntax structure of a tile parameter set (tile_parameter_set( )) (TPS) according to an embodiment of the present disclosure. According to embodiments, the TPS may also be referred to as a tile inventory. The TPS includes information related to each tile on a per-tile basis. In particular, in the illustrated example, it includes information related to refraction compensation.

The TPS according to the embodiments includes a num_tiles field.

The num_tiles field indicates the number of tiles signaled for the bitstream. When not present, num_tiles is inferred to be 0.

The TPS according to the embodiments includes an iteration statement repeated as many times as the value of the num_tiles field. In an embodiment, i is initialized to 0, and is incremented by 1 each time the iteration statement is executed. The iteration statement is repeated until the value of i becomes equal to the value of the num_tiles field. The iteration statement may include a tile_bounding_box_offset_x[i] field, a tile_bounding_box_offset_y[i] field, a tile_bounding_box_offset_z[i] field, a tile_bounding_box_size_width[i] field, a tile_bounding_box_size_height[i] field, and a tile_bounding_box_size_depth[i] field.

The tile_bounding_box_offset_x[i] field indicates the x offset of the i-th tile in the Cartesian coordinates.

The tile_bounding_box_offset_y[i] field indicates the y offset of the i-th tile in the Cartesian coordinates.

The tile_bounding_box_offset_z[i] field indicates the z offset of the i-th tile in the Cartesian coordinates.

The tile_bounding_box_size_width[i] field indicates the width of the i-th tile in the Cartesian coordinates.

The tile_bounding_box_size_height[i] field indicates the height of the i-th tile in the Cartesian coordinates.

The tile_bounding_box_size_depth[i] field indicates the depth of the i-th tile in the Cartesian coordinates.

According to embodiments, the TPS may include an optical_distortion_flag field.

The optical_distortion_flag field may indicate whether refraction compensation is performed on the point cloud data in the tile. optical_distortion_flag set to 1 may indicate that refraction compensation is performed, and optical_distortion_flag set to 0 may indicate that refraction compensation is not performed. In other words, the optical_distortion_flag field may signal whether refraction compensation is to be used for splitting of a road/object from the point cloud data in the tile.

When the value of the optical_distortion_flag field is true, indicating refraction compensation, the TPS may further include a theta_x field and a theta_y field.

theta_x indicates the x-axis coefficient in the refraction compensation equations (i.e., see Equation 1 to Equation 3), and theta_y indicates the y-axis coefficient in the refraction compensation equation (i.e., see Equation 1 to Equation 3). In other words, the transmission device may signal in the TPS the x-axis coefficient (theta_x) and the y-axis coefficient (theta_y) for the refraction compensation equations.

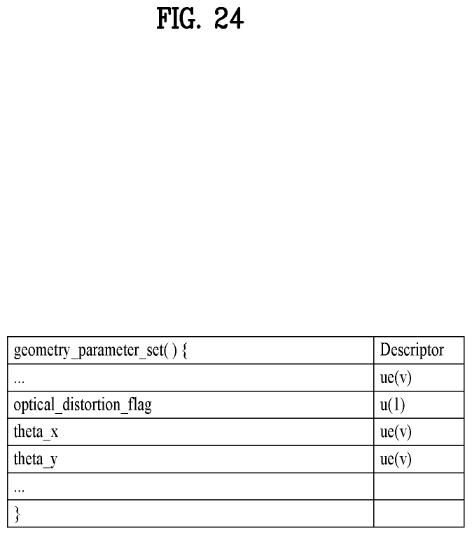

FIG. 24 shows a syntax structure of a geometry parameter set (geometry_parameter_set( )) (GPS) according to an embodiment of the present disclosure. In particular, FIG. 24 shows an example where the GPS further includes information related to refraction compensation.

In FIG. 24, the GPS may include an optical_distortion_flag field.

The optical_distortion_flag field may indicate whether the geometry information is refraction compensated. optical_distortion_flag set to 1 may indicate that refraction compensation is performed, and optical_distortion_flag set to 0 may indicate that refraction compensation is not performed. In other words, the optical_distortion_flag field may signal, in the geometry information, whether refraction compensation is to be used for road/object splitting.

When the value of the optical_distortion_flag field is true, indicating refraction compensation, the GPS may further include a theta_x field and a theta_y field.

theta_x indicates the x-axis coefficient in the refraction compensation equations (i.e., see Equation 1 to Equation 3), and theta_y indicates the y-axis coefficient in the refraction compensation equation (i.e., see Equation 1 to Equation 3). In other words, the transmission device may signal in the GPS the x-axis coefficient (theta_x) and the y-axis coefficient (theta_y) for the refraction compensation equations.

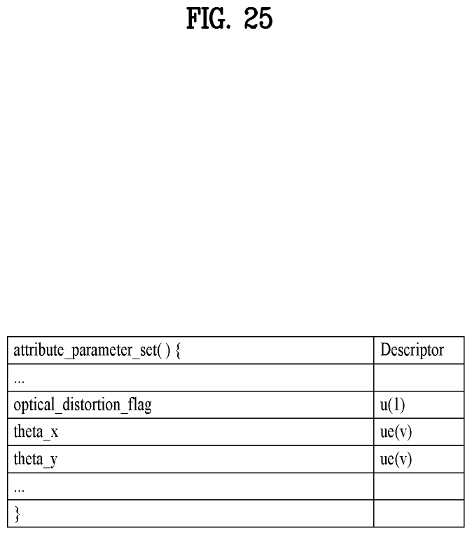

FIG. 25 shows a syntax structure of an attribute parameter set (attribute_parameter_set( )) (APS) according to an embodiment of the present disclosure. The APS may include information about a method of encoding attribute information related to the point cloud data contained in the one or more slices, and may further include information related to refraction compensation. In FIG. 25, the APS may include an optical_distortion_flag field.

The optical_distortion_flag field may indicate whether the geometry information (or attribute information) is refraction compensated. optical_distortion_flag set to 1 may indicate that refraction compensation is performed, and optical_distortion_flag set to 0 may indicate that refraction compensation is not performed. In other words, the optical_distortion_flag field may signal whether refraction compensation is to be used for road/object splitting in the geometry information (or attribute information).

When the value of the optical_distortion_flag field is true, indicating refraction compensation, the APS may further include a theta_x field and a theta_y field.

theta_x indicates the x-axis coefficient in the refraction compensation equations (i.e., see Equation 1 to Equation 3), and theta_y indicates the y-axis coefficient in the refraction compensation equation (i.e., see Equation 1 to Equation 3). In other words, the transmission device may signal in the APS the x-axis coefficient (theta_x) and the y-axis coefficient (theta_y) for the refraction compensation equations.

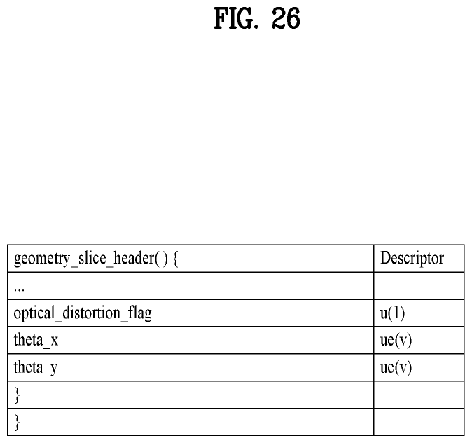

FIG. 26 shows a syntax structure of a geometry slice header (geometry_slice_header( )) according to an embodiment of the present disclosure.

A bitstream transmitted by the transmission device (or a bitstream received by the reception device) according to the embodiments may contain one or more slices. Each slice may include a geometry slice and an attribute slice. The geometry slice includes a geometry slice header (GSH). The attribute slice includes an attribute slice header (ASH).

The geometry slice header (geometry_slice_header( )) according to the embodiments may include an optical_distortion_flag field.

The optical_distortion_flag field may indicate whether refraction compensation is performed on the point cloud data in the geometry slice. optical_distortion_flag set to 1 may indicate that refraction compensation is performed, and optical_distortion_flag set to 0 may indicate that refraction compensation is not performed. In other words, the optical_distortion_flag field may signal whether refraction compensation is to be used for splitting of a road/object from the point cloud data in the geometry slice.

When the value of the optical_distortion_flag field is true, indicating refraction compensation, geometry slice header( ) may further include a theta_x field and a theta_y field.

theta_x indicates the x-axis coefficient in the refraction compensation equations (i.e., see Equation 1 to Equation 3), and theta_y indicates the y-axis coefficient in the refraction compensation equation (i.e., see Equation 1 to Equation 3). In other words, the transmission device may signal in the geometry slice header( ) the x-axis coefficient (theta_x) and the y-axis coefficient (theta_y) for the refraction compensation equations.

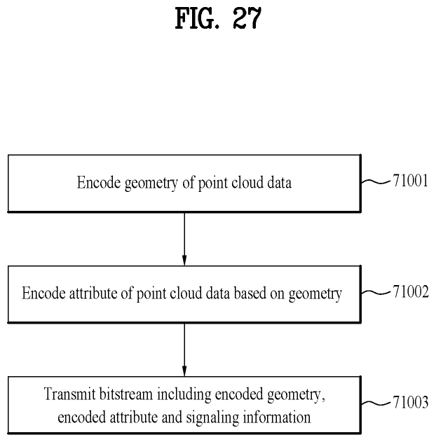

FIG. 27 is a flowchart of a method of transmitting point cloud data according to embodiments.

The method of transmitting point cloud data according to the embodiments may include encoding geometry included in the point cloud data (operation 71001), encoding attributes included in the point cloud data based on input and/or reconstructed geometry (operation 71002), and transmitting a bitstream containing the encoded geometry, the encoded attributes, and signaling information (operation 71003).

In one embodiment of the present disclosure, the point cloud data is acquired using a LiDAR system (e.g., a fixed LiDAR system or a spinning LiDAR system). For example, when assumed that the point cloud data is acquired using a fixed LiDAR system, each point in the point cloud data may have xyz coordinates in an optical coordinate system.

Operations 71001 and 71002 of encoding the geometry and attributes included in the point cloud data may include some or all of the operations of the point cloud video encoder 10002 of FIG. 1, the encoding 20001 of FIG. 2, the point cloud video encoder of FIG. 3, the point cloud video encoder of FIG. 8, the geometry encoder and attribute encoder of FIG. 15, the point cloud video encoder of FIG. 16, and the point cloud video encoder of FIG. 17.

According to embodiments, operation 71001 of encoding the geometry may include compensating for refraction based on the value of Z and/or compensating for refraction based on the values of X and Y in the xy plane before splitting the points in the point cloud data into a road and an object. Further, operation 71001 of encoding the geometry may include splitting the points in the point cloud data into a road and an object based on the value of Z.

According to embodiments, in operation 71001 of encoding the geometry, a prediction unit may be configured with the points split as the road and a prediction unit may be configured with the points split as the object (or object group). Then, inter-prediction or intra-prediction may be performed for each of the prediction units in a predictive tree structure (or octree structure) to compress the geometry split into the road and the object. That is, motion estimation/compensation may or may not be performed on each of the prediction units. For example, motion estimation/compensation may not be performed on the prediction unit composed of the points split as the road, but may be performed on the prediction unit composed of the points split as the object, or vice versa.

The compressed geometry information about each point is entropy encoded and output in the form of a geometry bitstream.

For details of compensating for the refraction of the points in the point cloud data, splitting the points into a road and an object, and compressing the geometry of the point cloud data split as the road and the geometry of the point cloud data split as the object(s), which will be described below, referred to the descriptions of FIGS. 10 to 17 and 21 to 26 above.

Operation 71003 of transmitting the bitstream containing the encoded geometry, encoded attributes, and signaling information may be performed by the transmitter 10003 of FIG. 1, the transmission 20002 of FIG. 2, the transmission processor 8012 of FIG. 8, or the transmission processor 51005 of FIG. 15.

According to embodiments, the refraction compensation-related information included in the signaling information may include information indicating whether refraction compensation is performed (optical_distortion_flag) and information for obtaining a value of Z (e.g., theta_x, theta_y), where theta_x indicates the x-axis coefficient in the refraction compensation equations (e.g., see Equation 1 or Equation 3) and theta_y indicates the y-axis coefficient in the refraction compensation equations (e.g., see Equation 1 or Equation 3). In the present disclosure, the refraction compensation-related information may be referred to as object detection structure information using refraction compensation. The signaling information including the refraction compensation-related information may be included in at least one of the SPS, GPS, TPS, APS, geometry slice header, or attribute slice header and transmitted to the reception device.

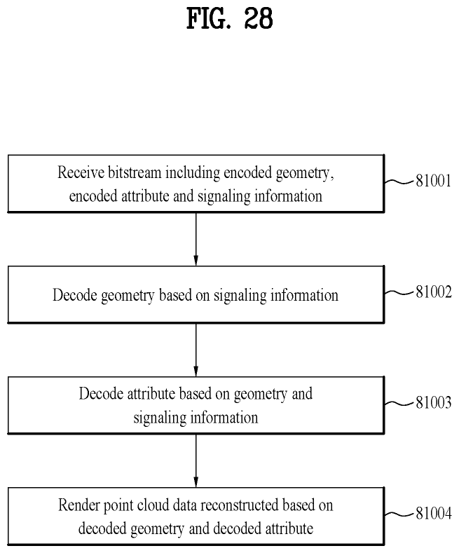

FIG. 28 is a flowchart of a method of receiving point cloud data according to embodiments.

The method of receiving point cloud data according to the embodiments may include receiving a bitstream containing encoded geometry, encoded attributes, and signaling information (operation 81001), and decoding the geometry based on the signaling information (operation 81002), decoding the attributes based on the decoded/reconstructed geometry and the signaling information (operation 81003), and rendering reconstructed point cloud data based on the decoded geometry and decoded attributes (operation 81004).

Operation 81001 of receiving the bitstream containing the encoded geometry, encoded attributes, and signaling information according to the embodiments may be performed by the receiver 10005 of FIG. 1, the transmission 20002 or decoding 20003 of FIG. 2, the receiver 9000 or reception processor 9001 of FIG. 9, or the reception processor 61001 of FIG. 18.

Operations 81002 and 81003 of decoding the geometry and attributes according to the embodiments may be performed per slice or per tile including one or more slices.

Operations 81002 and 81003 of decoding the geometry and attributes according to the embodiments may performing the decoding for each prediction unit including points split into a road and/or each prediction unit including points split into an object.

Operation 81002 of decoding the geometry according to the embodiments may include some or all of the operations of the point cloud video decoder 10006 of FIG. 1, the decoding 20003 of FIG. 2, the point cloud video decoder of FIG. 9, the point cloud video decoder of FIG. 18, the geometry decoder of FIG. 19, and the point cloud video decoder of FIG. 20.

Operation 81002 of decoding the geometry according to the embodiments may include performing a refraction compensation inverse transform based on refraction compensation-related information (e.g., optical_distortion_flag, theta_x, theta_y) included in the signaling information. Here, optical_distortion_flag indicates whether refraction compensation is applied, theta_x denotes the x-axis coefficient in the refraction compensation equations (i.e., see Equations 1 to 3), and theta_y denotes the y-axis coefficient in the refraction compensation equations (i.e., see Equations 1 to 3). When the optical_distortion_flag indicates that refraction compensation has been performed, a value of Z may be obtained based on theta_x and theta_y (see Equations 1 to 3), which may be used in performing refraction compensation inverse transform on the geometry bitstream.

According to embodiments, operation 81002 of decoding the geometry may include performing the refraction compensation inverse transform based on the refraction compensation-related information (e.g., optical_distortion_flag) included in the signaling information, and xmin, xmax, ymin, and ymax. Here, optical_distortion_flag indicates whether refraction compensation is performed. For example, when optical_distortion_flag indicates that refraction compensation is performed, the refraction compensation inverse transform may be performed by applying xmin, xmax, ymin, and ymax to Equation 4 to reconstruct the point cloud data configured before refraction compensation. Here, the amount of change in the x-axis ranges from xmin to xmax, and the amount of change in the y-axis ranges from ymin to ymax.

According to embodiments, xmin, xmax, ymin, and ymax may be set through the LiDAR system by obtaining the actual coordinates X and Y based the deflection angles θx and θy for the coordinates (x, y) scanned by the MEMS mirror, obtaining a minimum value xmin and a maximum value xmax among the values of X, and obtaining a minimum value ymin and a maximum value ymax among the values of Y.

According to other embodiments, xmin, xmax, ymin, and ymax may be obtained from signaling information, or may be calculated or inferred using other information (e.g., bounding box information and/or slice-related information).

According to embodiments, when the value of optical_distortion_flag is true, operation 81002 of decoding the geometry may include performing a refraction compensation inverse transform for road/object splitting. In other words, the refraction compensation inverse transform may be performed on the geometry bitstream based on the application status of refraction compensation and the coefficients theta_x, theta_y in the refraction compensation equations.

Operation 81003 of decoding the attributes according to the embodiments may include some or all of the operations of the point cloud video decoder 10006 of FIG. 1, the decoding 20003 of FIG. 2, the point cloud video decoder of FIG. 9, the point cloud video decoder of FIG. 18, the attribute decoder of FIG. 19, and the point cloud video decoder of FIG. 20.

According to embodiments, the signaling information, for example, at least one of the sequence parameter set, the geometry parameter set, the attribute parameter set, the tile parameter set, the geometry slice header, and the attribute slice header, may include information related to refraction compensation.

Operation 81004 of rendering the reconstructed point cloud data based on the decoded geometry and decoded attributes according to the embodiments may include rendering the reconstructed point cloud data according to various rendering schemes. For example, the points in the point cloud content may be rendered as a vertex having a certain thickness, a cube having a certain minimum size centered at the corresponding vertex position, or a circle centered at the vertex position. All or a portion of the rendered point cloud content may be presented to a user through a display (e.g., VR/AR display, conventional display, etc.).

Operation 81004 of rendering point cloud data according to the embodiments may be performed by the renderer 10007 of FIG. 1, the rendering 20004 of FIG. 2, or the renderer 9011 of FIG. 9.

As such, the present disclosure may improve the compression efficiency of geometry information by splitting a road and an object after compensating for refraction of the point cloud data prior to point cloud compression, and compressing the geometry information related to the road and object. In particular, the present disclosure may be applied to point cloud data acquired by a fixed LiDAR system to further improve the compression efficiency of the geometry information. Further, the refraction compensation method and the object detection method using the same may be used for intra-/inter-frame object search, thereby further improving the compression efficiency based on the characteristics of the object.

Each part, module, or unit described above may be a software, processor, or hardware part that executes successive procedures stored in a memory (or storage unit). Each of the steps described in the above embodiments may be performed by a processor, software, or hardware parts. Each module/block/unit described in the above embodiments may operate as a processor, software, or hardware. In addition, the methods presented by the embodiments may be executed as code. This code may be written on a processor readable storage medium and thus read by a processor provided by an apparatus.

In the specification, when a part “comprises” or “includes” an element, it means that the part further comprises or includes another element unless otherwise mentioned. Also, the term “ . . . module (or unit)” disclosed in the specification means a unit for processing at least one function or operation, and may be implemented by hardware, software or combination of hardware and software.

Although embodiments have been explained with reference to each of the accompanying drawings for simplicity, it is possible to design new embodiments by merging the embodiments illustrated in the accompanying drawings. If a recording medium readable by a computer, in which programs for executing the embodiments mentioned in the foregoing description are recorded, is designed by those skilled in the art, it may fall within the scope of the appended claims and their equivalents.

The apparatuses and methods may not be limited by the configurations and methods of the embodiments described above. The embodiments described above may be configured by being selectively combined with one another entirely or in part to enable various modifications.

Although preferred embodiments of the embodiments have been shown and described, the embodiments are not limited to the specific embodiments described above, and various modifications may be made by one of ordinary skill in the art without departing from the spirit of the embodiments claimed in the claims, and such modifications should not be understood in isolation from the technical ideas or views of the embodiments.

Various elements of the apparatuses of the embodiments may be implemented by hardware, software, firmware, or a combination thereof. Various elements in the embodiments may be implemented by a single chip, for example, a single hardware circuit. According to embodiments, the components according to the embodiments may be implemented as separate chips, respectively. According to embodiments, at least one or more of the components of the apparatus according to the embodiments may include one or more processors capable of executing one or more programs. The one or more programs may perform any one or more of the operations/methods according to the embodiments or include instructions for performing the same. Executable instructions for performing the method/operations of the apparatus according to the embodiments may be stored in a non-transitory CRM or other computer program products configured to be executed by one or more processors, or may be stored in a transitory CRM or other computer program products configured to be executed by one or more processors. In addition, the memory according to the embodiments may be used as a concept covering not only volatile memories (e.g., RAM) but also nonvolatile memories, flash memories, and PROMs. In addition, it may also be implemented in the form of a carrier wave, such as transmission over the Internet. In addition, the processor-readable recording medium may be distributed to computer systems connected over a network such that the processor-readable code may be stored and executed in a distributed fashion.

In this document, the term “/” and “,” should be interpreted to indicate “and/or.” For instance, the expression “A/B” may mean “A and/or B.” Further, “A, B” may mean “A and/or B.” Further, “A/B/C” may mean “at least one of A, B, and/or C.” Also, “A/B/C” may mean “at least one of A, B, and/or C.” Further, in the document, the term “or” should be interpreted to indicate “and/or.” For instance, the expression “A or B” may comprise 1) only A, 2) only B, and/or 3) both A and B. In other words, the term “or” in this document should be interpreted to indicate “additionally or alternatively.”

Various elements of the embodiments may be implemented by hardware, software, firmware, or a combination thereof. Various elements in the embodiments may be executed by a single chip such as a single hardware circuit. According to embodiments, the element may be selectively executed by separate chips, respectively. According to embodiments, at least one of the elements of the embodiments may be executed in one or more processors including instructions for performing operations according to the embodiments.

Operations according to the embodiments described in this specification may be performed by a transmission/reception device including one or more memories and/or one or more processors according to embodiments. The one or more memories may store programs for processing/controlling the operations according to the embodiments, and the one or more processors may control various operations described in this specification. The one or more processors may be referred to as a controller or the like. In embodiments, operations may be performed by firmware, software, and/or combinations thereof. The firmware, software, and/or combinations thereof may be stored in the processor or the memory.

Terms such as first and second may be used to describe various elements of the embodiments. However, various components according to the embodiments should not be limited by the above terms. These terms are only used to distinguish one element from another. For example, a first user input signal may be referred to as a second user input signal. Similarly, the second user input signal may be referred to as a first user input signal. Use of these terms should be construed as not departing from the scope of the various embodiments. The first user input signal and the second user input signal are both user input signals, but do not mean the same user input signal unless context clearly dictates otherwise. The terminology used to describe the embodiments is used for the purpose of describing particular embodiments only and is not intended to be limiting of the embodiments. As used in the description of the embodiments and in the claims, the singular forms “a”, “an”, and “the” include plural referents unless the context clearly dictates otherwise. The expression “and/or” is used to include all possible combinations of terms. The terms such as “includes” or “has” are intended to indicate existence of figures, numbers, steps, elements, and/or components and should be understood as not precluding possibility of existence of additional existence of figures, numbers, steps, elements, and/or components.

As used herein, conditional expressions such as “if” and “when” are not limited to an optional case and are intended to be interpreted, when a specific condition is satisfied, to perform the related operation or interpret the related definition according to the specific condition. Embodiments may include variations/modifications within the scope of the claims and their equivalents. It will be apparent to those skilled in the art that various modifications and variations can be made in the present disclosure without departing from the spirit and scope of the disclosure. Thus, it is intended that the present disclosure cover the modifications and variations of this disclosure provided they come within the scope of the appended claims and their equivalents.

### MODE FOR DISCLOSURE

The details have been specifically described in the best mode for the disclosure.

### INDUSTRIAL APPLICABILITY

It is evident to those skilled in the art that various modifications and variations are possible within the scope of the embodiments without departing from the spirit or scope of the embodiments. Therefore, the embodiments are intended to encompass the modifications and variations of the embodiments provided within the appended claims and their equivalents.

1. A method of transmitting point cloud data, the method comprising:
acquiring point cloud data using a light detection and ranging (LiDAR) system;
encoding the point cloud data; and
transmitting the encoded point cloud data and signaling information.

2. The method of claim 1, wherein the encoding of the point cloud data comprises:
compensating for refraction occurring in the point cloud data;
splitting points in the refraction-compensated point cloud data into a road and an object; and
encoding geometry information including positions of points spilt into the road and the object and attribute information including one or more attribute values of the points spilt into the road.

3. The method of claim 2, wherein the signaling information comprises refraction compensation-related information of the point cloud data.

4. The method of claim 2, wherein the compensating for refraction comprises compensating for the refraction of the points in the point cloud data based on a value of Z in position information (X, Y, Z) about the points.

5. The method of claim 4, wherein:
values of X and Y in the position information (X, Y, Z) are acquired based on deflection angles acquired by scanning a laser beam of the LiDAR system along an x-axis and y-axis and target distance information related to the laser beam; and
the value of Z is acquired based on the values of X and Y, the deflection angles, and the target distance information related to the laser beam.

6. The method of claim 4, wherein the compensating for refraction comprises:
compensating for refraction of the points in the point cloud data by applying a threshold according to positions of the points in the point cloud data in an xy plane.

7. The method of claim 4, wherein the splitting of the road and the object comprises:
classifying each of the points in the point cloud data as the road or the object based on the value of Z of a corresponding one of the points.

8. A device for transmitting point cloud data, comprising:
an acquirer configured to acquire point cloud data using a light detection and ranging (LiDAR) system;
an encoder configured to encode the point cloud data; and
a transmitter configured to transmit the encoded point cloud data and signaling information.

9. The device of claim 8, wherein the encoder comprises:
a refraction compensator configured to compensate for refraction occurring in the point cloud data;
a road-object splitter configured to split points in the refraction-compensated point cloud data into a road and an object; and
an encoder configured to encode geometry information including positions of points spilt into the road and the object and to encode attribute information including one or more attribute values of the points spilt into the road.

10. The device of claim 9, wherein the signaling information comprises refraction compensation-related information of the point cloud data.

11. The device of claim 9, wherein the refraction compensator compensates for the refraction of the points in the point cloud data based on a value of Z in position information (X, Y, Z) about the points.

12. The device of claim 11, wherein:
values of X and Y in the position information (X, Y, Z) are acquired based on deflection angles acquired by scanning a laser beam of the LiDAR system along an x-axis and y-axis and target distance information related to the laser beam; and
the value of Z is acquired based on the values of X and Y, the deflection angles, and the target distance information related to the laser beam.

13. The device of claim 11, wherein the refraction compensator compensates for refraction of the points in the point cloud data by applying a threshold according to positions of the points in the point cloud data in an xy plane.

14. The device of claim 11, wherein the road-object splitter classifies each of the points in the point cloud data as the road or the object based on the value of Z of a corresponding one of the points.

15. A method of receiving point cloud data, the method comprising:
receiving compressed point cloud data and signaling information;
decoding the point cloud data based on the signaling information; and
rendering the decoded point cloud data based on the signaling information;
wherein the decoding of the point cloud data comprises:
performing a refraction compensation inverse transform on the compressed point cloud data; and
reconstructing geometry information and attribute information of the point cloud data subjected to the refraction compensation inverse transform,
wherein the signaling information comprises refraction compensation-related information of the point cloud data.
